(19) United States
(12) Patent Application Publication
(10) Pub. No.: US 2016/0140460 A1
(43) Pub. Date: May 19, 2016

(54) SYSTEMS AND METHODS FOR AN INTEGRATED ONLINE PORTAL AND MARKETPLACE FOR EVENT-RELATED ITEMS

(71) Applicant: Boost3, LLC, Boston, MA (US)

(72) Inventor: Robert T. Boyd, JR., Brookline, MA (US)

(21) Appl. No.: 15/000,868

(22) Filed: Jan. 19, 2016

Related U.S. Application Data
(63) Continuation of application No. 13/897,985, filed on May 20, 2013.
(60) Provisional application No. 61/649,726, filed on May 21, 2012.

(51) Int. Cl. G06Q 10/02; G06Q 30/06; G06Q 50/00

(52) U.S. Cl. CPC G06Q 10/02; G06Q 50/01; G06Q 30/0631; G06Q 30/0641

(57) ABSTRACT

The present disclosure is directed to systems and methods for integration of systems associated with ticketing, advertising, membership, social networking, merchandizing, and/or similar commercially valuable functions. An integrated marketplace system, referred to variously as an integrated system or integrated portal, may comprise or communicate with modules for retail services, social networking, marketing information, ticketing sales, merchandise sales, membership services, or any other type and form of module. In some embodiments, the systems and methods discussed herein allow teams, bands, event operators or other attraction providers to sell tickets direct to consumers or fans, reducing fees and costs due to ticket resellers, while retaining customer information for future targeted marketing. Accordingly, teams, bands, artists, or other attractions may utilize the integrated platform to provide a fan- or consumer-centric experience with ticket sales and merchandise offers made dynamically based on analyzing user behavior, past purchasing behavior, and/or social networking data.

### RELATED APPLICATION

The present application is a continuation of and claims priority to U.S. patent application Ser. No. 13/897,985, titled “Systems and Methods For An Integrated Online Portal and Marketplace For Event-Related Items” and filed on May 20, 2013, which claims the benefit of and priority to U.S. Provisional Application No. 61/649,726, titled “Systems and Methods For An Integrated Online Portal and Marketplace For Event-Related Items” and filed on May 21, 2012, both of which are incorporated herein by reference in their entirety for all purposes.

### FIELD OF THE INVENTION

The present disclosure relates to systems and methods for providing an integrated online portal and marketplace for event-related items. In particular, the present disclosure relates to an integrated platform for ticket and merchandise sales, analysis of consumer behavior, and monetization of predicted behavior data.

### BACKGROUND OF THE INVENTION

Presently, sales of tickets for major events, such as sporting events, concerts, or similar attractions are handled via one or two online ticketing providers, with each provider typically holding a monopoly over a particular venue, event or event type, etc. As a result, consumers who visit a team website, for example, wishing to purchase a ticket are typically redirected to a second website of the ticket provider. Although frames or similar systems may be used to return the user to the team website after purchase, such operations may not work properly on mobile devices or devices with no ability to show multiple pages simultaneously.

Similarly, merchandise related to a team, band, or similar attraction is typically sold through an online store or retail provider, which may be a separate entity from either the ticket provider or the team, band, or similar attraction. The user experience may be degraded and branding and marketing opportunities may be lost as a result. For example, a user visiting a team website may be shown ads for upcoming games, ads for team merchandise, etc. However, when the user clicks on such an ad to purchase a ticket or merchandise, the user may be directed to the website of the corresponding provider, which may display ads for non-team related events or merchandise, potentially distracting or confusing the user and resulting in lost opportunities for up-selling or cross-selling.

For example, referring briefly to FIG. 2A, illustrated is a block diagram of an embodiment of a typical system for selling tickets, merchandise, or providing other information. A client 200, which may comprise a client computing device, mobile device, or other device operated on behalf of a user or consumer, may communicate with a plurality of servers 202a-202c, each providing different services. A first server 202a, such as a server hosting a website operated by a sports team, may provide marketing information and event information to the client 200. A second server 202b may provide ticket sales and may be associated with the venue. In some embodiments, control over entry to the venue may be provided by a system at the venue 204, such as ticket verification services or similar systems. A third server 202c may provide merchandise sales, such as t-shirts, posters, autographed memorabilia, etc. As shown, the user may need to visit multiple websites or communicate with multiple, disparate systems. This may require repeated logins, repeated entry of credit card numbers or addresses, or similar steps. Additionally, the systems typically have little to no capability for communication between each other, or to third party systems, such as social network providers.

### BRIEF SUMMARY OF THE INVENTION

The present disclosure is directed to systems and methods for integration of systems associated with ticketing, advertising, membership, social networking, merchandizing, and/or similar commercially valuable functions. As shown in the block diagram illustrated in FIG. 2B, in one embodiment, an integrated marketplace system 206, referred to variously as an integrated system or integrated portal, may communicate with a client 200 and comprise or communicate with modules for retail services, social networking, marketing information, ticketing sales, merchandise sales, membership services, or any other type and form of module. In some embodiments, the systems and methods discussed herein allow teams, bands, event operators or other attraction providers to sell tickets direct to consumers or fans, reducing fees and costs due to ticket resellers, while retaining customer information for future targeted marketing. Accordingly, teams, bands, artists, or other attractions may utilize the integrated platform to provide a fan- or consumer-centric experience with ticket sales and merchandise offers made dynamically based on analyzing user behavior, past purchasing behavior, and/or social networking data. For example, the integrated portal may provide a single checkout or shopping cart system to allow a user to buy tickets, ringtones, videos, posters, t-shirts, hats, or other tangible items, or non-tangible services, such as an opportunity to meet an athlete, band member, or artist in person, concierge service or catering at the event, roses delivered to the user's seat, etc. In some embodiments, based on user demographic data (e.g. age, geography, wealth, occupation, common interests, etc.) from social networking providers, such as via a Facebook page of the team or band, the portal may predict likely purchase behavior of the user. In other embodiments, past purchase activity of the user on the system may be used or combined with social networking predictive behavior to recommend fan-based purchase packages, such as tickets to an event and a t-shirt or DVD of the event, or offer up-sell opportunities, such as the option to upgrade into better seats if the user also purchases a pair of items of merchandise. By providing such diverse sales opportunities in an integrated portal, the provider may take advantage of different profit margins to provide discounts for package purchases. Additionally, in many embodiments, the portal further allows teams, bands, or event operators to communicate with an extended “passive” fan base not at the venue, increasing both online and offline sales. In some embodiments, the portal may help improve fan engagement and build loyalty by approaching the customer via a communication channel of choice, such as through a social network platform or via text messages. In many embodiments, the portal may be provided by an online service provider, as an online service or platform-as-a-service (PaaS), reducing the requirement of a team or band to provide their own information technology services for communicating with fans.

The details of various embodiments of the invention are set forth in the accompanying drawings and the description below.

### BRIEF DESCRIPTION OF THE FIGURES

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising local machines in communication with remote machines;

FIGS. 1B-1C are block diagrams depicting embodiments of computers useful in connection with the methods and systems described herein;

FIG. 2A is a block diagram of an embodiment of typical systems for selling tickets, merchandise, or providing other information;

FIG. 2B is a block diagram of an embodiment of an integrated marketplace system for selling tickets, merchandise, and analyzing user behavior and social network information to predict purchase behavior;

FIG. 2C is another block diagram of an embodiment of an integrated marketplace system;

FIG. 3A is a block diagram of an embodiment of an enterprise management system for operating an integrated portal;

FIG. 3B is a block diagram of an embodiment of the enterprise management system;

FIG. 3C is a block diagram of another embodiment of the enterprise management system;

FIG. 3D is a block diagram of an exemplary embodiment of an integrated portal and marketplace system provided for a sports team;

FIG. 3E is a flow diagram of data through an embodiment of the enterprise management system;

FIG. 3F is a block diagram of an embodiment of an enterprise management system illustrating communication with clients via an API;

FIG. 4 is a flow diagram of a method of tracking and rewarding customer behavior; and

FIGS. 5A-5M are screenshots of an example embodiment of an integrated online portal.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION OF THE INVENTION

For purposes of reading the description of the various embodiments below, the following descriptions of the sections of the specification and their respective contents may be helpful:
Section A describes a network environment and computing environment which may be useful for practicing embodiments described herein;
Section B describes embodiments of systems and methods for providing an integrated online marketplace; and
Section C describes exemplary embodiments of an improved online marketplace.

### A: Network and Computing Environment

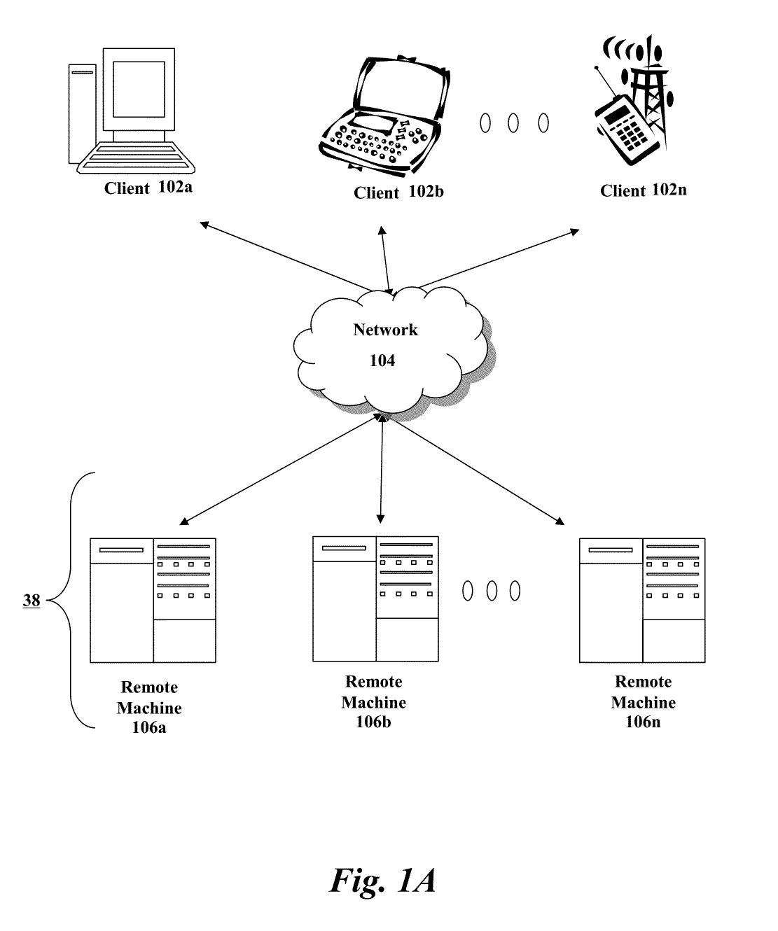

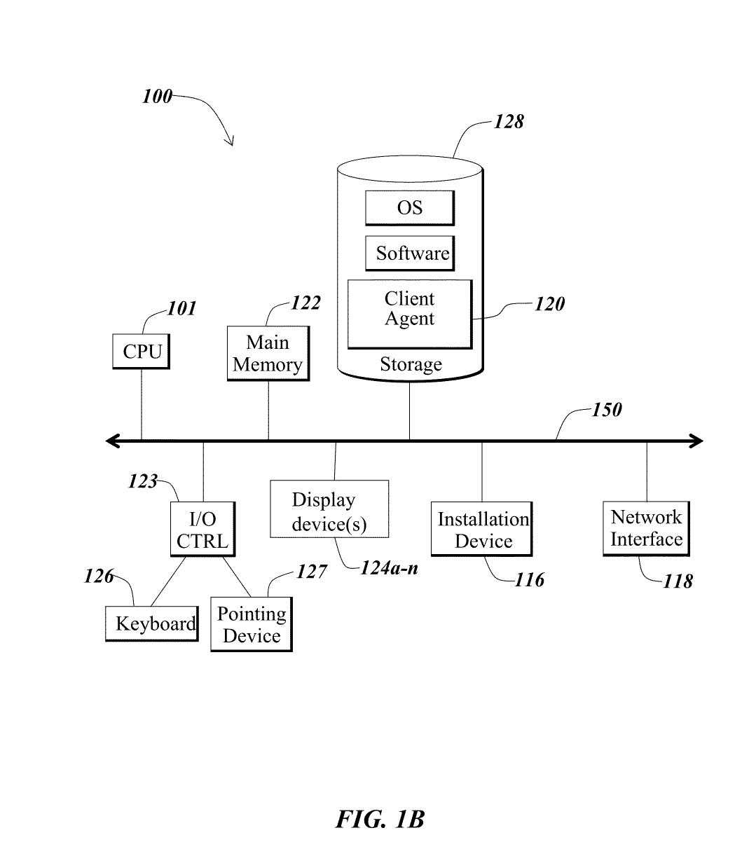

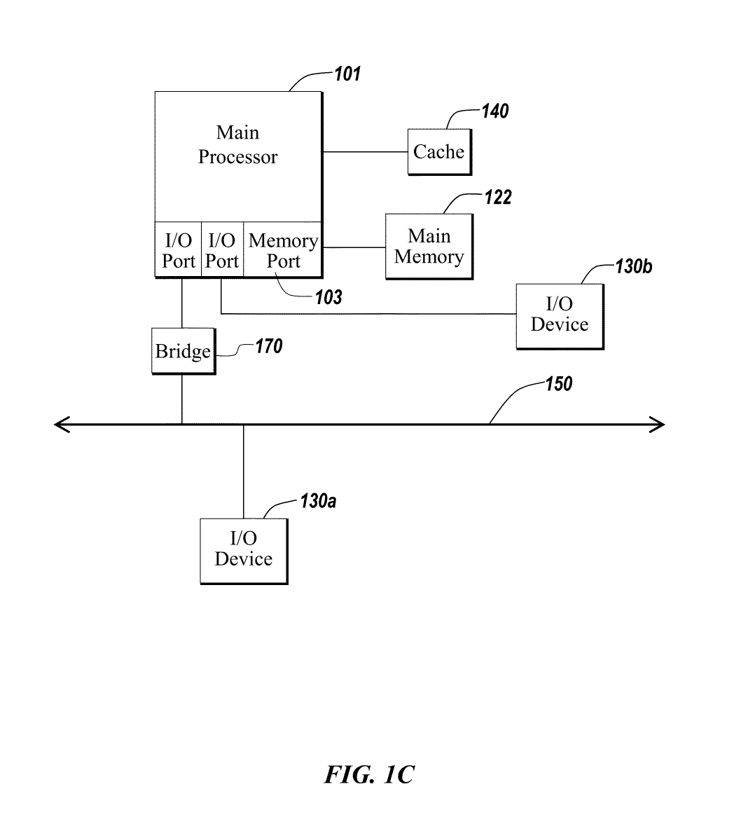

Referring now to FIG. 1A, an embodiment of a network environment is depicted. In brief overview, the network environment includes one or more clients 102a-102n (also generally referred to as local machine(s) 102, node(s) 102, client(s) 102, client node(s) 102, client machine(s) 102, client computer(s) 102, client device(s) 102, endpoint(s) 102, or endpoint node(s) 102) in communication with one or more remote machines 106a-106n (also generally referred to as server(s) 106 or remote machine(s) 106) via one or more networks 104. In some embodiments, a client 102 has the capacity to function as both a client node 102 seeking access to resources provided by a server and as a server providing access to hosted resources for other clients 102a-102n.

Although FIG. 1A shows a network 104 between the clients 102 and the remote machines 106, the clients 102 and the remote machines 106 may be on the same network 104. The network 104 can be a local-area network (LAN), such as a company Intranet, a metropolitan area network (MAN), or a wide area network (WAN), such as the Internet or the World Wide Web. In some embodiments, there are multiple networks 104 between the clients 102 and the remote machines 106. In one of these embodiments, a network 104′ (not shown) may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS. In some embodiments, different types of data may be transmitted via different protocols. In other embodiments, the same types of data may be transmitted via different protocols.

In some embodiments, the system may include multiple, logically-grouped remote machines 106. In one of these embodiments, the logical group of remote machines may be referred to as a server farm 38 or a machine farm 38. In another of these embodiments, the remote machines 106 may be geographically dispersed. In other embodiments, a server farm 38 may be administered as a single entity. In still other embodiments, the server farm 38 includes a plurality of server farms 38. The remote machines 106 within each server farm 38 can be heterogeneous—one or more of the remote machines 106 or machines 106 can operate according to one type of operating system platform (e.g., WINDOWS NT, manufactured by Microsoft Corp. of Redmond, Wash.), while one or more of the other remote machines 106 can operate on according to another type of operating system platform (e.g., Unix or Linux).

In one embodiment, remote machines 106 in the server farm 38 may be stored in high-density rack systems, along with associated storage systems, and located in an enterprise data center. In this embodiment, consolidating the remote machines 106 in this way may improve system manageability, data security, the physical security of the system, and system performance by locating remote machines 106 and high performance storage systems on localized high performance networks. Centralizing the remote machines 106 and storage systems and coupling them with advanced system management tools allows more efficient use of server resources.

The remote machines 106 of each server farm 38 do not need to be physically proximate to another remote machine 106 in the same server farm 38. Thus, the group of remote machines 106 logically grouped as a server farm 38 may be interconnected using a wide-area network (WAN) connection or a metropolitan-area network (MAN) connection. For example, a server farm 38 may include remote machines 106 physically located in different continents or different regions of a continent, country, state, city, campus, or room. Data transmission speeds between remote machines 106 in the server farm 38 can be increased if the remote machines 106 are connected using a local-area network (LAN) connection or some form of direct connection. Additionally, a heterogeneous server farm 38 may include one or more remote machines 106 operating according to a type of operating system, while one or more other remote machines 106 execute one or more types of hypervisors rather than operating systems. In these embodiments, hypervisors may be used to emulate virtual hardware, partition physical hardware, virtualize physical hardware, and execute virtual machines that provide access to computing environments. Hypervisors may include those manufactured by VMWare, Inc., of Palo Alto, Calif., the Xen hypervisor, an open source product whose development is overseen by Citrix Systems, Inc., the VirtualServer or virtual PC hypervisors provided by Microsoft, or others.

Remote machine 106 may be a file server, application server, web server, proxy server, appliance, network appliance, gateway, gateway server, virtualization server, deployment server, SSL VPN server, or firewall. In some embodiments, a remote machine 106 provides a remote authentication dial-in user service, and is referred to as a RADIUS server. In other embodiments, a remote machine 106 may have the capacity to function as either an application server or as a master application server. In still other embodiments, a remote machine 106 is a blade server. In yet other embodiments, a remote machine 106 executes a virtual machine providing, to a user or client computer 102, access to a computing environment.

A computing device 100 may execute, operate or otherwise provide an application, which can be any type and/or form of software, program, or executable instructions such as any type and/or form of web browser, web-based client, client-server application, a thin-client computing client, an ActiveX control, or a Java applet, or any other type and/or form of executable instructions capable of executing on the computing device 100. In some embodiments, the application may be a server-based or a remote-based application executed on behalf of a user of a first computing device by a second computing device. In other embodiments, the second computing device may display output data to the first, client computing device using any thin-client or remote-display protocol, such as the Independent Computing Architecture (ICA) protocol manufactured by Citrix Systems, Inc. of Ft. Lauderdale, Fla.; the Remote Desktop Protocol (RDP) manufactured by the Microsoft Corporation of Redmond, Wash.; the X11 protocol; the Virtual Network Computing (VNC) protocol, manufactured by AT&T Bell Labs; the SPICE protocol, manufactured by Qumranet, Inc., of Sunnyvale, Calif., USA, and of Raanana, Israel; the Net2Display protocol, manufactured by VESA, of Milpitas, Calif.; the PC-over-IP protocol, manufactured by Teradici Corporation, of Burnaby, B.C.; the TCX protocol, manufactured by Wyse Technology, Inc., of San Jose, Calif.; the THINC protocol developed by Columbia University in the City of New York, of New York, N.Y.; or the Virtual-D protocols manufactured by Desktone, Inc., of Chelmsford, Mass. The application can use any type of protocol and it can be, for example, an HTTP client, an FTP client, an Oscar client, or a Telnet client. In other embodiments, the application comprises any type of software related to voice over internet protocol (VoIP) communications, such as a soft IP telephone. In further embodiments, the application comprises any application related to real-time data communications, such as applications for streaming video and/or audio.

The client 102 and remote machine 106 may be deployed as and/or executed on any type and form of computing device, such as a computer, network device or appliance capable of communicating on any type and form of network and performing the operations described herein. FIGS. 1B and 1C depict block diagrams of a computing device 100 useful for practicing an embodiment of the client 102 or a remote machine 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-124n, a keyboard 126 and a pointing device 127, such as a mouse. The storage device 128 may include, without limitation, an operating system, software, and a client agent 120. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In some embodiments, the central processing unit 121 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output DRAM (EDO DRAM), Burst Extended Data Output DRAM (BEDO DRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 122 may be based on any of the above described memory chips, or any other available memory chips capable of operating as described herein. In the embodiment shown in FIG. 1B, the processor 121 communicates with main memory 122 via a system bus 150 (described in more detail below). FIG. 1C depicts an embodiment of a computing device 100 in which the processor communicates directly with main memory 122 via a memory port 103. For example, in FIG. 1C the main memory 122 may be DRDRAM.

FIG. 1C depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1C, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with a display device 124. FIG. 1C depicts an embodiment of a computer 100 in which the main processor 121 communicates directly with I/O device 130b via HYPERTRANSPORT, RAPIDIO, or INFINIBAND communications technology. FIG. 1C also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices include keyboards, mice, trackpads, trackballs, microphones, dials, and drawing tablets. Output devices include video displays, speakers, inkjet printers, laser printers, and dye-sublimation printers. The I/O devices may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices such as the USB Flash Drive line of devices manufactured by Twintech Industry, Inc., of Los Alamitos, Calif.

Referring again to FIG. 1B, the computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, a flash memory drive, tape drives of various formats, USB device, hard-drive or any other device suitable for installing software and programs. The computing device 100 may further comprise a storage device, such as one or more hard disk drives or redundant arrays of independent disks, for storing an operating system and other related software, and for storing application software programs such as any program related to the client agent 120. Optionally, any of the installation devices 116 could also be used as the storage device. Additionally, the operating system and the software can be run from a bootable medium, for example, a bootable CD, such as KNOPPIX, a bootable CD for GNU/Linux that is available as a GNU/Linux distribution from knoppix.net.

Furthermore, the computing device 100 may include a network interface 118 to interface to the network 104 through a variety of connections including, but not limited to, standard telephone lines, LAN or WAN links (e.g., 802.11, T1, T3, 56kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, CDMA, GSM, WiMax and direct asynchronous connections). In one embodiment, the computing device 100 communicates with other computing devices 100′ via any type and/or form of gateway or tunneling protocol such as Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, a Serial Attached small computer system interface bus, or a HDMI bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS MOBILE, WINDOWS XP, and WINDOWS VISTA, all of which are manufactured by Microsoft Corporation of Redmond, Wash.; MAC OS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

The computer system 100 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 100 has sufficient processor power and memory capacity to perform the operations described herein. For example, the computer system 100 may comprise a device of the IPOD, IPAD, or IPHONE families of devices manufactured by Apple Computer of Cupertino, Calif., a PLAYSTATION 2, PLAYSTATION 3, or PERSONAL PLAYSTATION PORTABLE (PSP) device manufactured by the Sony Corporation of Tokyo, Japan, a NINTENDO DS, NINTENDO GAMEBOY, NINTENDO GAMEBOY ADVANCED or NINTENDO REVOLUTION device manufactured by Nintendo Co., Ltd., of Kyoto, Japan, or an XBOX or XBOX 360 device manufactured by the Microsoft Corporation of Redmond, Wash.

In some embodiments, the computing device 100 may have different processors, operating systems, and input devices consistent with the device. For example, in one embodiment, the computing device 100 is a TREO 180, 270, 600, 650, 680, 700p, 700w/wx, 750, 755p, 800w, Centro, or Pro smart phone manufactured by Palm, Inc. In some of these embodiments, the TREO smart phone is operated under the control of the PalmOS operating system and includes a stylus input device as well as a five-way navigator device.

In other embodiments, the computing device 100 is a mobile device, such as a JAVA-enabled cellular telephone or personal digital assistant (PDA), such as the i55sr, i58sr, i85s, i88s, i90c, i95cl, i335, i365, i570, 1576, i580, i615, i760, i836, i850, i870, i880, i920, i930, ic502, ic602, ic902, i776 or the im1100, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea. In some embodiments, the computing device 100 is a mobile device manufactured by Nokia of Finland, or by Sony Ericsson Mobile Communications AB of Lund, Sweden.

In still other embodiments, the computing device 100 is a Blackberry handheld or smart phone, such as the devices manufactured by Research In Motion Limited, including the Blackberry 7100 series, 8700 series, 7700 series, 7200 series, the Blackberry 7520, the Blackberry PEARL 8100, the 8700 series, the 8800 series, the Blackberry Storm, Blackberry Bold, Blackberry Curve 8900, and the Blackberry Pearl Flip. In yet other embodiments, the computing device 100 is a smart phone, Pocket PC, Pocket PC Phone, or other handheld mobile device supporting Microsoft Windows Mobile Software. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some embodiments, the computing device 100 is a digital audio player. In one of these embodiments, the computing device 100 is a digital audio player such as the Apple IPOD, IPOD Touch, IPOD NANO, and IPOD SHUFFLE lines of devices, manufactured by Apple Computer of Cupertino, Calif. In another of these embodiments, the digital audio player may function as both a portable media player and as a mass storage device. In other embodiments, the computing device 100 is a digital audio player such as the DigitalAudioPlayer Select MP3 players, manufactured by Samsung Electronics America, of Ridgefield Park, N.J., or the Motorola m500 or m25 Digital Audio Players, manufactured by Motorola Inc. of Schaumburg, Ill. In still other embodiments, the computing device 100 is a portable media player, such as the ZEN VISION W, the ZEN VISION series, the ZEN PORTABLE MEDIA CENTER devices, or the Digital MP3 line of MP3 players, manufactured by Creative Technologies Ltd. In yet other embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 includes a combination of devices, such as a mobile phone combined with a digital audio player or portable media player. In one of these embodiments, the computing device 100 is a Smartphone, for example, an IPHONE manufactured by Apple Computer, or a Blackberry device, manufactured by Research In Motion Limited. In yet another embodiment, the computing device 100 is a laptop or desktop computer equipped with a web browser and a microphone and speaker system, such as a telephony headset. In these embodiments, the computing devices 100 are web-enabled and can receive and initiate phone calls. In other embodiments, the communications device 100 is a Motorola RAZR or Motorola ROKR line of combination digital audio players and mobile phones.

### B. Integrated Online Marketplace

Systems and methods for integration of systems associated with ticketing, advertising, membership, social networking, merchandizing, and/or similar commercially valuable functions may provide integrated online portals allowing opportunities to use data to predict user behavior. Customer relationship management (CRM) principles may be utilized to provide additional value to customer data, allowing sports and entertainment vendors to gain insight into what motivates which customers, when, and why, allowing personalization of the fan engagement experience to attract millions of individuals in ways that are important to them. This may result in a loyal fan base, lower costs, and increased profitability. Teams, bands, artists, or other attractions may utilize the integrated platform to provide a fan- or consumer-centric experience with ticket sales and merchandise offers made dynamically based on analyzing user behavior, past purchasing behavior, and/or social networking data. For example, the integrated portal may provide a single checkout or shopping cart system to allow a user to buy tickets, ringtones, videos, posters, t-shirts, hats, or other tangible items, or non-tangible services, such as an opportunity to meet an athlete, band member, or artist in person, concierge service or catering at the event, roses delivered to the user's seat, etc. In some embodiments, based on user demographic data (e.g. age, geography, wealth, occupation, common interests, etc.) from social networking providers, such as via a Facebook page of the team or band, the portal may predict likely purchase behavior of the user. In other embodiments, past purchase activity of the user on the system may be used or combined with social networking predictive behavior to recommend fan-based purchase packages, such as tickets to an event and a t-shirt or DVD of the event, or offer up-sell opportunities, such as the option to upgrade into better seats if the user also purchases a pair of items of merchandise. By providing such diverse sales opportunities in an integrated portal, the provider may take advantage of different profit margins to provide discounts for package purchases.

The integrated portal may provide a sales channel for all types of inventory, including tangible items, such as books, clothing, or other goods; intangible items, such as e-books, movies, songs, or television shows; admission or access tickets, such as concert or sports tickets, museum tickets, plane tickets, train or bus tickets; access tokens, such as those used to access an online service, multiplayer network game, cloud computing application; or any other type and form of item, event, service, or attraction. Inventory may be limited in supply, as in the case of seats to a particular concert; limited in time, as in the case where tickets to an event may be useless after the event occurs; temporarily limited in supply, as in the case of a newly released video game system; limited in a combination of these; or not limited at all. Inventory may be fungible, such as a copy of a software program, or non-fungible, such as a particular seat to a sporting event. Single items, tickets, tokens, attractions, services, or other singular units of inventory may be referred to generally as an item or ticket. In many embodiments, the term inventory may not refer to the specific item, but rather an identifier of the item. For example, when a concert promoter provides 100 admission tickets of inventory to the online marketplace, in many embodiments, the concert promoter sells the 100 admission tickets to the marketplace operator, provides a contract to sell the 100 admission tickets at a future date, provides an identifier that the 100 admission tickets have been sold although they remain in the possession of the concert promoter, etc. Thus, tangible items may not actually change hands when inventory is provided to the marketplace. Inventory may be acquired from original providers of the inventory, resellers, or online marketplaces.

In some embodiments, the integrated portal may provide ticket purchase opportunities for sporting events, concert events, lectures, or other shows. Events may occur at specific places and times, although multiple instances of the event may occur, such as multiple shows. The system may handle different types of events, particular teams, performers, or any other type and form of entertainment attraction. Additionally, in some embodiments, the system may be utilized for non-entertainment events, such as plane tickets, restaurant reservations or pre-paid tickets, commuter rail passes, ferry trips, hotel reservations, or any other type and form of tangible or intangible item or service.

The integrated system may provide a web portal, and/or web shop, which may accessed by a user or client's computing device or mobile device, such as a smart phone or tablet. In some embodiments, the integrated system may transmit communications, updates, recommendations, or other notifications to user computer devices, via one or more communications channels, including text or multimedia messaging to a phone, Facebook or Twitter status updates, email, or any other type and form of communications channel. In many embodiments, computing devices communicating with the integrated system may be used by retailers and/or venue operators, such as point-of-sale (POS) terminals, ticket verification devices, concession stand payment devices, or any other type and form of computing devices.

In one embodiment, the integrated system may comprise one or more modules that may be included in the system or excluded to reduce complexity, based on need. For example, in one embodiment, the integrated system may comprise a module for an event operator, such as a sports team, to control customer data, pricing, and cash receipts. In other embodiments, the integrated system may comprise a module allowing an event sponsor, such as a concert underwriter, to review customer data or demographics. In still other embodiments, the integrated system may comprise a module allowing consumers, fans, users, or customers to participate in online discussion groups or fan clubs, sign up or configure memberships, view merchandise for purchase, receive loyalty rewards or other benefits, and view personalized recommendations of events, merchandise, and/or services for purchase. In still another embodiment, the integrated system may provide modules for fan segmentation, data/behavior predictive analytics of user purchases, and presentation of demographic and statistical data, based on past purchase behaviors.

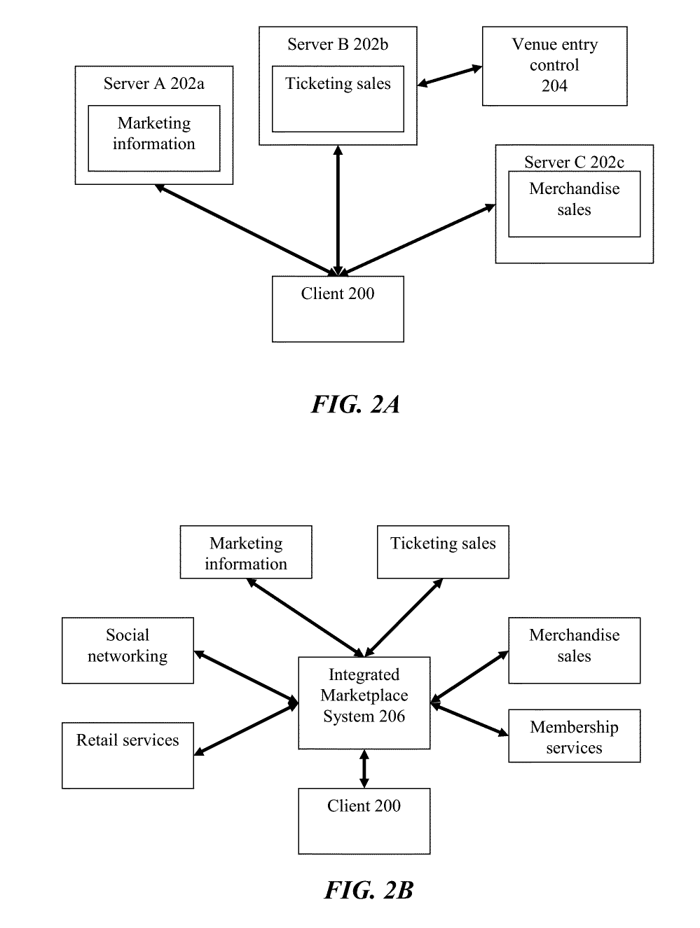

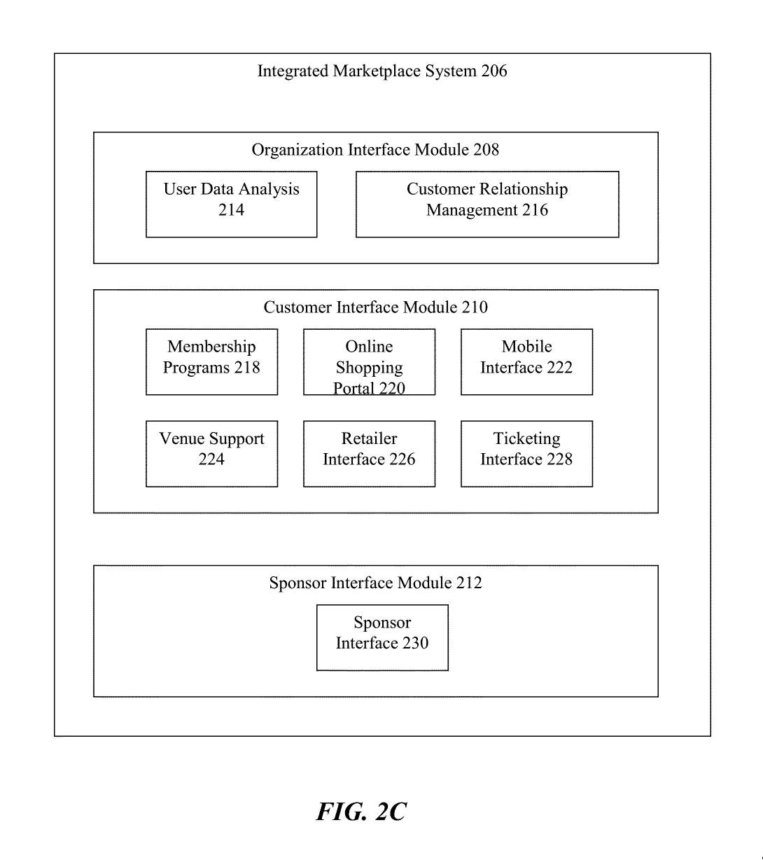

For example, referring to FIG. 2C, illustrated is a block diagram of an embodiment of an integrated marketplace system 206 comprising three modules, organization interface module 208, customer interface module 210, and sponsor interface module 212. In many embodiments, the system 206 may comprise a greater or fewer number of modules. As shown, in many embodiments, modules 208-212 may each further comprise one or more modules 214-230.

In some embodiments, an organization interface module 208, sometimes referred to as a team module, may comprise a user data analysis module 214. User data analysis module 214 may comprise functionality for single sign-on via one or more social networks, such as Facebook, Twitter, LinkedIn, Yahoo Groups, Google+, or any other type and form of social network. Teams or other organizations may analyze, segment, and report on fans or consumer data in real time or near real time, with data provided via purchase history, social network profile data, ticket purchase databases, ecommerce databases, or other systems. Customer relationship management module 216 may comprise functionality to allow organizations to communicate with consumers based on criteria defined by user data analysis module 214, such as notifications regarding potential product offerings or exclusive ticket offers, loyalty rewards, or other communications. In some embodiments, communication methods and channels can be selected to support email, text or multimedia messaging, video or voice messaging, instant messaging, or social network communications, such as those provided by Twitter or Facebook. In some embodiments, user data analysis module 214 and/or customer relationship management module 216 may provide statistical reports of consumer behavior, demographic information and/or changes over time. For example, a report may comprise information about the gender, age, race, household income, amount of time spent on the internet, percentage of internet use spent visiting predetermined sites or performing predetermined categories of functions (e.g. watching streaming television programs, viewing sports scores or updates, participating in fantasy sports, etc.). Such reports may be useful in generating demographic-specific offers and discounts.

In some embodiments, a customer interface module 210, sometimes referred to as a fan module, may comprise a membership program module 218. A membership program module 218 may comprise functionality for loyalty or membership programs connecting users or fans with their teams, bands, or artists. In some embodiments, the module may allow the user or fan to collect loyalty points to be used towards purchases, both online and offline. In some embodiments, the module may provide for a “freemium” model, such as a free membership which can be upgraded to a paid membership with additional benefits or privileges. In some embodiments, depending on the level of membership, the user or fan may get discounts on tickets, venues, merchandise, or services, as well as invitations to VIP events with members of teams or bands, or backstage access with performers at a venue.

In another embodiment, the customer interface module 210 may comprise an online shopping portal 220. Portal 220 may comprise an online store of merchandise for the team, band, or other attraction, integrated with offline venue retail shops, such as booths selling t-shirts or live-recorded albums. This may help to support promotions, loyalty, and membership benefits for the fan base.

In still another embodiment, the customer interface module may comprise a mobile interface module 222. Mobile interface module 222 may comprise functionality for communicating with applications on mobile devices, such as iOS apps for the Apple iPhone or Android apps for Android-based smart phones. In some embodiments, module 222 may comprise a web server, ftp server, or any other type and form of data server for communicating with mobile applications and/or web browsers.

In some embodiments, customer interface module 210 may comprise a venue support module 224, for a stadium, theater, or other venue. Venue support module 224 may comprise functionality for interfacing with computing devices at the venue, or allowing the venue to provide ticket or hospitality benefits to the membership programs 218.

In some embodiments, customer interface module 210 may comprise a retailer interface 226. Retailer interface 226 may allow third-party retailers, such as stores, bars, restaurants, and other retailers to support promotions, loyalty and membership benefits from the team or band to the fan base. For example, in one embodiments, retailer interface 226 may be used to allow a third-party retailer to offer a discount to members or allow members to earn membership points through purchases, potentially subsidized by the team or band.

In many embodiments, customer interface module 210 may comprise a ticketing interface 228. Ticketing interface 228 may comprise a server or service for allowing fans or consumers to buy tickets direct from the team, band, artist, or other attraction, rather than through ticket resellers. In some embodiments, discounts or rewards associated with membership programs 218 may be applied by ticketing interface 228.

In some embodiments, a sponsor interface module 212 may comprise a sponsor interface 230 for allowing sponsors of the team, band, artist, event, or attraction to communicate with consumers or fans. For example, a team sponsor, such as a local coffee shop, may provide discounts for fans on the purchase of products through interface module 212, including both online purchases and offline purchases.

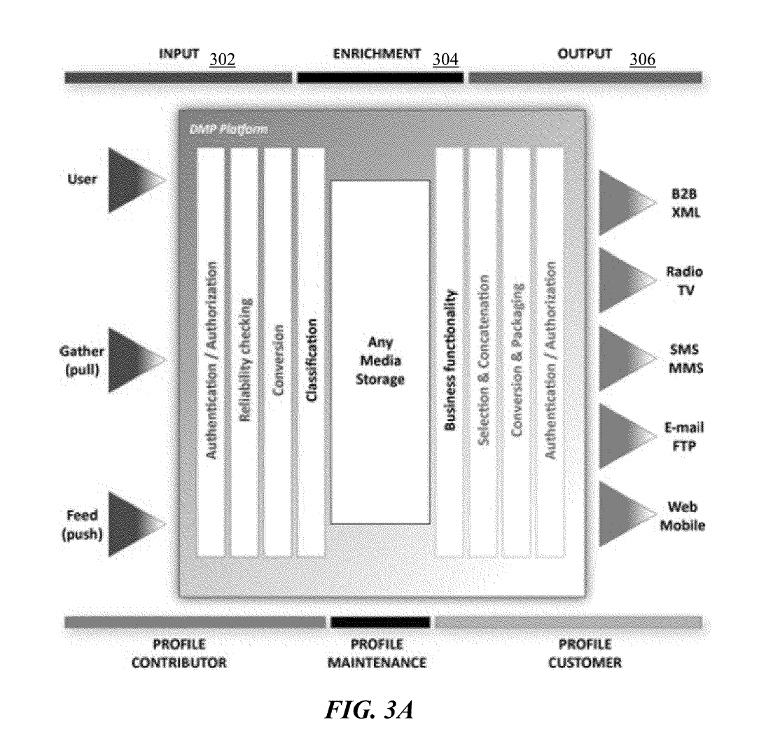

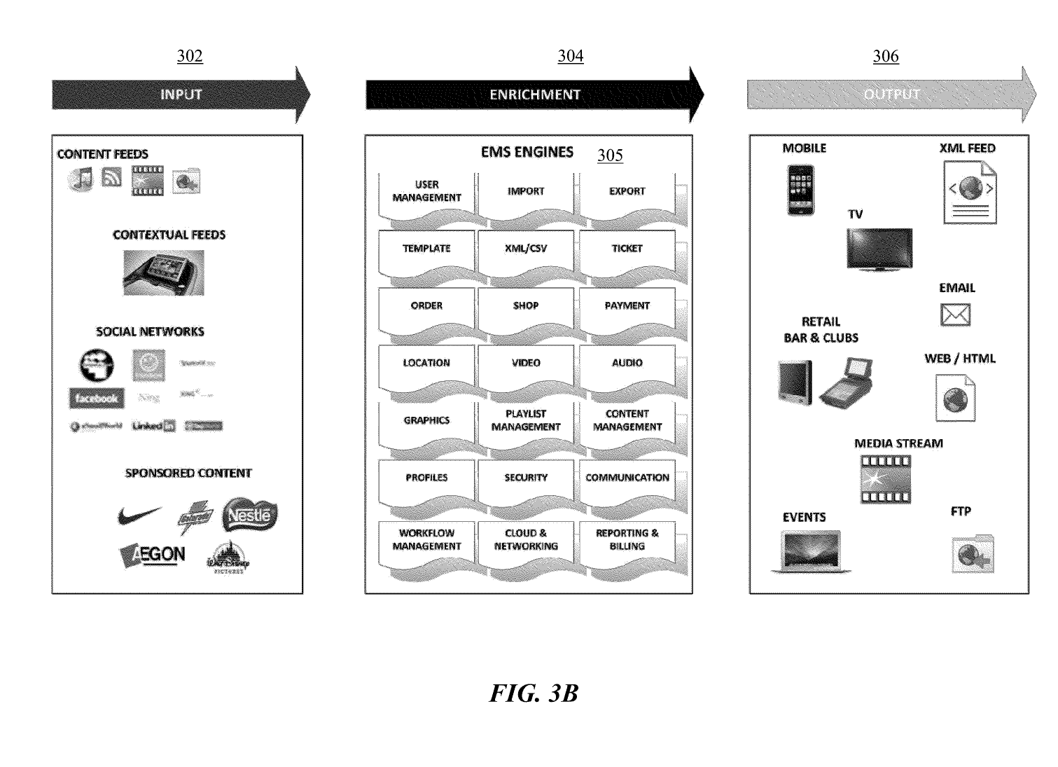

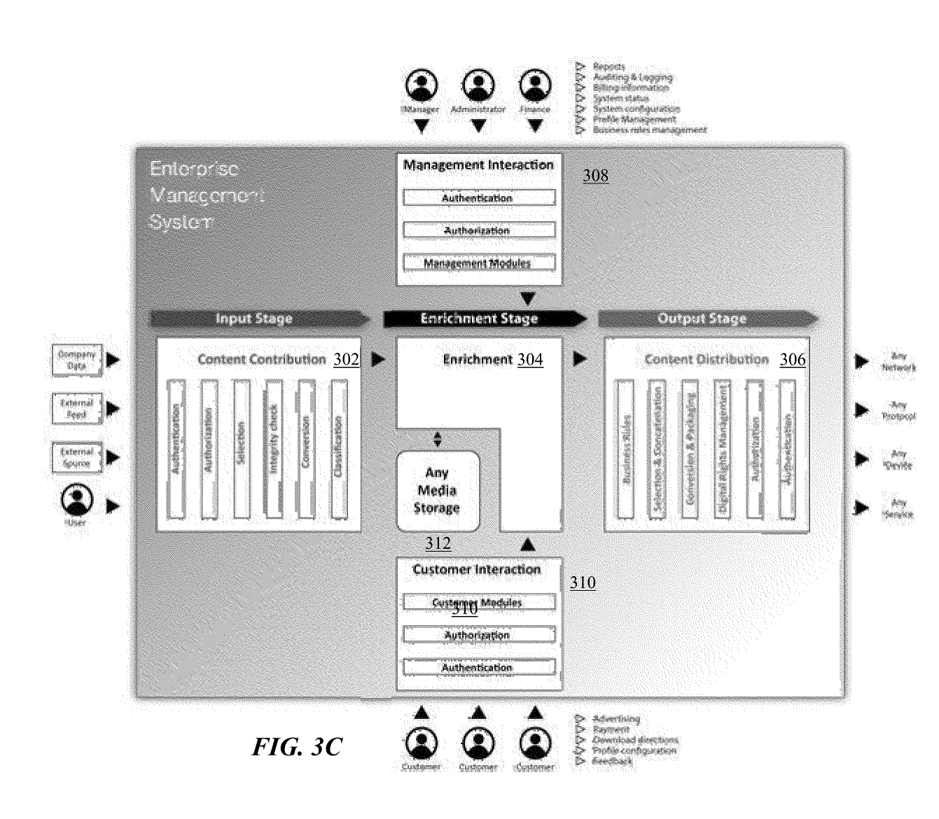

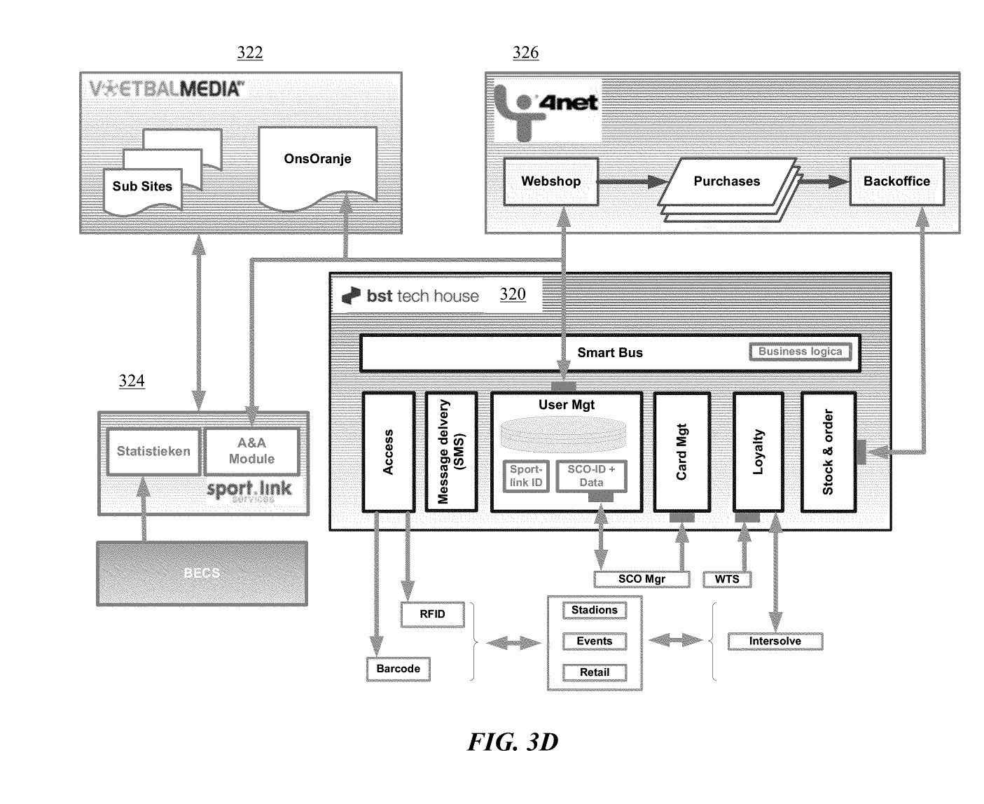

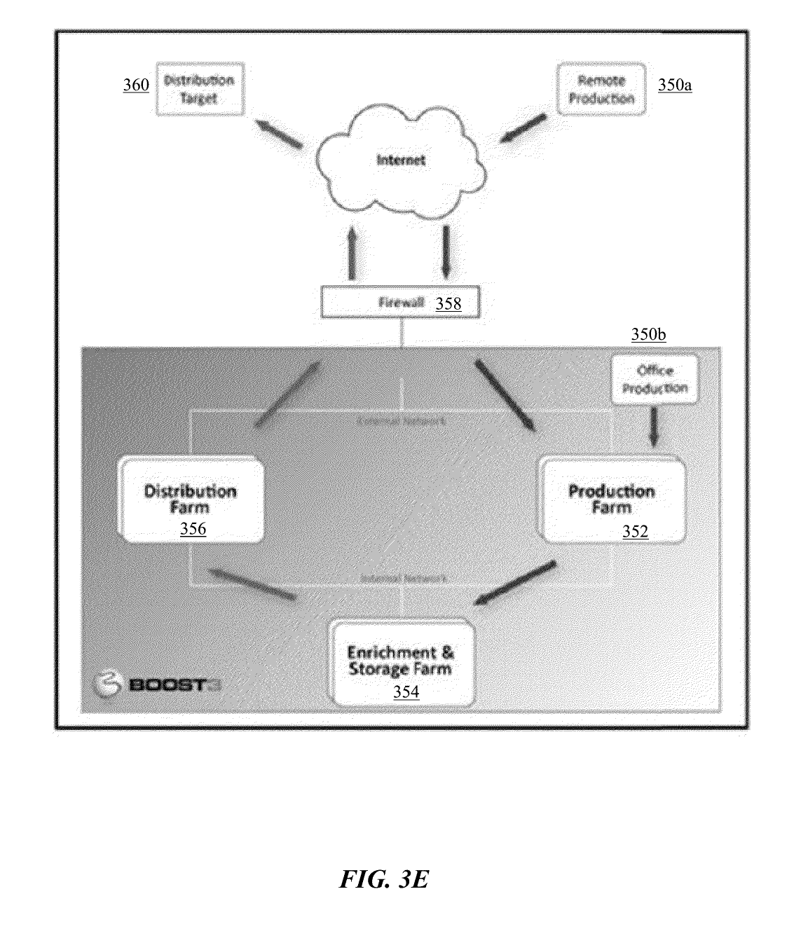

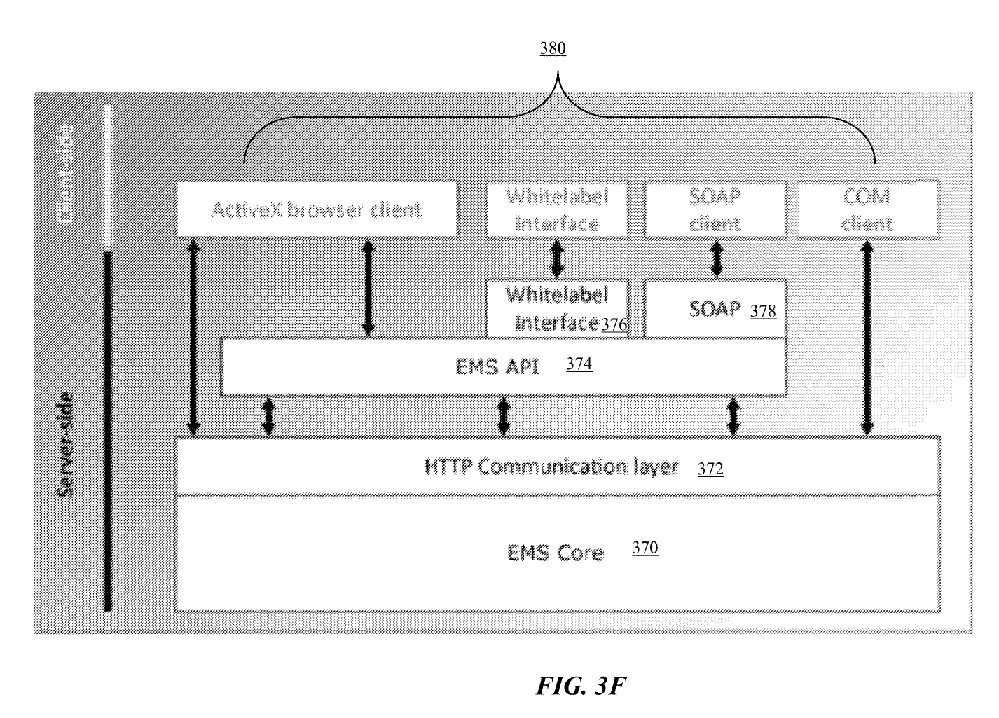

In many embodiments, the integrated portal may comprise an enterprise management system (sometimes referred to as “EMS”). The enterprise management system provides a framework for working with various data, such as user purchase data, social networking data, or other types of data. Referring now to FIG. 3A, illustrated is a block diagram of a data processing model used in the enterprise management system. In brief overview, data or content is acquired in an input stage 302. Data or content may enter the platform on a push or feed basis (in case the system/user with the information source takes the initiative in transmitting data) or on a pull/retrieve basis (in which the enterprise management system may retrieve data from remote data sources). The input stage 302 may comprise functionality for interacting with different kinds of data sources, including existing data repositories, such as customer databases, media storage, or similar data collections; external data feeds, such as RSS feeds; external sources comprising structured data; or data obtained directly from users.

During an enrichment stage 304, data may be processed and business rules, sometimes referred to as management profiles, may be applied. Business rules may include analysis of consumer demographics, purchasing habits, associations between consumers and past consumers, etc. Enrichment may further comprise monitoring and logging, activity scheduling and load balancing, customer accounting, transaction handling, billing, report generation. In some embodiments, the system may comprise an application or service for managing profiles or rules. In many embodiments, access to the application or service may be delegated to remote computing devices or users, such as sponsors or venue operators.

Data is output during an output stage 306, and delivered through various distribution channels, such as XML data or similar data delivered to venues, attraction operators, retailers, etc.; email; ftp; delivery via web pages, mobile applications, text or multimedia messaging, or broadcast feeds. Customer and Distribution Profiles define which data the customer has access to, how it should be formatted and what communication mechanism should be used for delivery. This means that the delivery of the information can be tailored to the specific wishes of the customer. For example, it is possible to deliver the same set of information to customer A by means of email and to customer B by means of SMS. The technical implications (different formatting, different communication mechanisms, etc.) are hand led by the platform and controlled by the profiles.

In some embodiments, each stage may be separated from others, allowing for independence between the input stage and output stage. Changes at either side may not directly affect the other stages and can be implemented independently. For example, in some embodiments, it may be possible to add additional communication mechanisms for output stage 306, without affecting input stage 302, or vice versa. Similarly, business logic may be developed independently of input and output stages, regardless of specific techniques used for delivery. Separation also allows for optimization of the different stages. Due to the highly distinct role of each stage, each stage can be optimized specifically for the role it plays. Optimization can be done per stage in the areas of performance, capacity, availability and scalability. For example, the system may be scaled to serve a greater number of users by scaling the appropriate output stages.

Referring briefly to FIG. 3B, in many embodiments, enrichment stage 304 may comprise execution of one or more enterprise management system engines 305. Each engine is responsible for a sub process within the enterprise management system.

In one embodiment, the enterprise management system comprises a user management engine. The user management engine may comprise an application, service, server, routine, process, or other executable logic for managing users, groups, and accounts attached to an extended credential array that describes rights within the system. In some embodiments, the user management engine may be used for authentication, authorization, registration, providing a social networking hub, user profiles, groups, accounts, rights and role management, and similar functions.

In one embodiment, the enterprise management system comprises an import engine. The import engine may comprise an application, service, server, routine, process, or other executable logic for importing data or content on a push or feed basis, or on a pull or retrieve basis, as discussed above. In many embodiments, data may be imported according to a template defining content and header fields, in various data formats such as XML, text, comma-separated values, etc., and may comprise data files including audio, video, tables, executable files, documents, etc. In another embodiment, the enterprise management system may comprise an export engine. The export engine may comprise an application, service, server, routine, process, or other executable logic for exporting enriched data or content, as discussed above. In many embodiments, data may be exported according to a template defining content and header fields, in various data formats such as XML, text, comma-separated values (CSV), HTML, etc., and may comprise data files including audio, video, documents, multimedia streams, etc.

In one embodiment, the enterprise management system may comprise a template engine. The template engine may comprise an application, service, server, routine, process, or other executable logic for generating and editing templates for transforming any data input into any data output. In some embodiments, the enterprise management system may comprise XML/CSV engine. The XML/CSV engine may comprise an application, service, server, routine, process, or other executable logic for parsing or processing XML or CVS data.

In one embodiment, the enterprise management system may comprise a ticket engine. The ticket engine may comprise an application, service, server, routine, process, or other executable logic for creating, selling, and checking tickets, as discussed above. In another embodiment, the enterprise management system may comprise an order engine. The order engine may comprise an application, service, server, routine, process, or other executable logic for creating, processing and delivering orders, such as customer orders for merchandise. In many embodiments, the order and/or ticket engines may communicate with a shop engine. The shop engine may comprise an application, service, server, routine, process, or other executable logic for providing an online store, or for supporting an offline store, such as providing product overview, product search/filtering, providing product information and/or pricing, localization, shopping cart or basket functionality, etc. In some embodiments, the order, ticket or shop engines may also communicate with a payment engine. The payment engine may comprise an application, service, server, routine, process, or other executable logic for end-user payment actions, including receiving and handling payment information and communicating with third-party payment providers such as credit card companies, banks, Paypal, or other entities.

In one embodiment, the enterprise management system may comprise a location engine. The location engine may comprise an application, service, server, routine, process, or other executable logic for tracking location based data, including GPS data, IP-based location data, cellular-based location data, RFID location data, etc.

In some embodiments, the enterprise management system may comprise an audio and/or video engine. The audio and video engines may each comprise an application, service, server, routine, process, or other executable logic for processing audio and video, respectively, including encoding, transcoding between different formats, decoding, streaming, and online editing. In other embodiments, the enterprise management system may comprise a graphics engine. The graphics engine may comprise an application, service, server, routine, process, or other executable logic for processing graphics, including format conversion, size conversion or scaling, and applying graphic filters.

In one embodiment, the enterprise management system may comprise a playlist management engine. The playlist management engine may comprise an application, service, server, routine, process, or other executable logic for supporting the automatic creation of playlists for both audio and video assets, including adding or inserting tracks or content; randomized playback with verification of artist uniqueness or filtered by attributes including artist, title, category, etc.; programming of designated start times; multi-playlist mixing and interleaving; multi-output assignment; and narrowcasting and support for digital signage. In another embodiment, the enterprise management system may comprise a content management engine. The content management engine may comprise an application, service, server, routine, process, or other executable logic for performing content enrichment, including profile-based content set selection, integrated rights management; and production team hierarchy support (including pre-publish, publish, blocked, expired, follow up, etc.).

In one embodiment, the enterprise management system may comprise a profile engine. The profile engine may comprise an application, service, server, routine, process, or other executable logic for applying profiles through the enterprise management system, including user profiles, group profiles, content profiles, pricing profiles, communication profiles, device profiles, location profiles, time profiles, or profiles based on any other attribute. In another embodiment, the enterprise management system may comprise a security engine. The security engine may comprise an application, service, server, routine, process, or other executable logic for providing encryption, SSL communication, MD5 hashing, CRC verification, digital rights management, CAPTCHA support, access control list support, LDAP profiles, or any other security feature. In yet another embodiment, the enterprise management system may comprise a communication engine. The communication engine may comprise an application, service, server, routine, process, or other executable logic for supporting various layer protocols, including HTTP/HTTPS, FTP, SMTP, MAPI, RTSP, or any other type and form of protocol. In many embodiments, communication engine may provide support for telephony protocols, such as SMS, MMS, interactive voice response (IVR), facsimile, or any other type and form of protocol.

In another embodiment, the enterprise management system may comprise a cloud/networking engine. The cloud/networking engine may comprise an application, service, server, routine, process, or other executable logic for providing reliability, load balancing, and other cloud features, including communication between master and slave servers, automatic failover, mirroring, stream server replication, virtual machine management and provisioning, or any similar features. In some embodiments, to minimize downtime, multiple servers may be used in a service farm to provide one or more components of the enterprise management system. Any node in the farm may perform the duties of other nodes if ordered to do so, and in some embodiments, system administrators may move node duties around in the farm if required to minimize server-maintenance downtime. Platform duties may be split across a plurality of servers so that processor intensive tasks can be executed on dedicated notes.

Referring briefly ahead to FIG. 3F, illustrated is a flow diagram of data through an embodiment of the enterprise management system. In some embodiments, audio and video may be generated at a remote production environment 350a or a local or office product environment 350b. Processing and enriching such content may be very processor intensive. Accordingly, in the embodiment illustrated, creation, processing and distributing the data may be split into logical segments, comprising one or more production servers 352, one or more enrichment and storage servers 354, and one or more distribution servers 356. As necessary, servers may be moved between segments 352-356, or additional servers added to handle additional data. Actions can be sequenced through the server farm utilizing system queues. Accordingly, the farm may be scaled both horizontally as well as vertically. Additional security may be provided through a firewall 358 or other network security devices.

Returning to FIG. 3B, in one embodiment, the enterprise management system may comprise a workflow management engine. The workflow management engine may comprise an application, service, server, routine, process, or other executable logic for implementing dependencies in business processes, such as content- or process-based workflow management. In another embodiment, the enterprise management system may comprise a reporting/billing engine. The reporting/billing engine may comprise an application, service, server, routine, process, or other executable logic for delivering customizable reports to a user or third party, including multi-format reports, sales reporting, technical reporting, financial reporting, custom-based reporting, or any other type and form of reports.

Referring now to FIG. 3C, illustrated is a block diagram of an embodiment of the enterprise management system. As shown, the enterprise management system may comprise modules for input, enrichment, and output stages 302-306. In some embodiments, the enterprise management system may further comprise media storage 312 or communicate with one or more media storage devices. In some embodiments, the enterprise management system may comprise a management interaction module 308. Management interaction module 308 may provide functionality for authentication, authorization, and management of other modules, and may in many embodiments, be used by managers, administrators, or finance department staff to generate reports, performing auditing and logging, generate billing information, manage system status and configuration, and manage profiles and business rules, as discussed above.

In many embodiments, management interaction module 308 may comprise a user management module. The user management comprises users, groups and accounts that are attached to an extended credential array that describes the rights within the system. Users inherit the credentials of the groups they belong to. This adds to the rights and possibilities users have. Users and groups inherit the credentials from the account they be long to. In many embodiments, the account is restrictive, meaning that a user or group cannot have rights assigned that exceed the rights granted to an account. For example, in one such embodiment, a user can be an Administrator. The user is part of the Administrators group and thus inherits all its rights from that group. But, the user is also linked to the account of company A. The rights granted to the account of company A do not allow for management tasks of company B. The user can thus perform all management tasks (due to membership of the group Administrators) for company A but not for company B (due to linkage to the account of company A). In many embodiments, the credential array is implementation specific. For some implementations this means that the credentials are restricted to the availability of menu choices, for other it could go as far as deciding whether a conversion of data is accessible or not.

In addition to input, enrichment, and output stages 302-306, in many embodiments, the enterprise management system comprises functionality for one or more of:
Network distribution of content from decentralized sources, such as remote computing devices, and delivery in a multitude of file formats;
Multi-user profiling to match each user with personal media items or content of interest, fine tuned to user preferences;
Just-in-time broadcasting and distribution of sound or video streams compiled in real time, using archived sound and video data and real-time input.
Metadata query framework allowing query of the database to find items of interest to a browsing user.
Device transparency, allowing playback of sound, video, images, and formatted text regardless of specific device format requirements;
Workflow management to implement dependencies in business processes;
Mobile integration, including location based services through GPS;
Online payment systems for e-commerce and communication with existing vendors;
Reporting and billing, including statistical analysis of usage;
Digital rights management and encryption; and
A/D and D/A conversion of analog multimedia formats.

In some embodiments, the enterprise management system may comprise a customer interaction module 310, which may comprise functionality for authentication and authorization of users or customers, and provide a portal for customers to view advertising, provide feedback, configure user profiles, and initiate payment for services or merchandise.

In one embodiment, administrators or managers may manage the enterprise management system via a desktop or web application tool, referred to as the enterprise management desktop (EMD). In many embodiments, EMD may comprise a reporting module for generating and delivering customizable reports in any format requested by a user or a third party. In some embodiments, the user may manually download reports provided by the reporting module, while in other embodiments, the reporting module may automatically send reports through email or via other communication channels to one or more users or administrators.

In some embodiments, the enterprise management system may comprise an API that serves as a protocol format abstraction layer, as well as allowing terminology to be modified responsive to customer requests. For example, in one such embodiment, a database management command may have a title of “GetMediaList” when used in developing an online media player, or may be given a title of “GetMessageList” when used in developing a discussion board. The API thus enables implementers to work with a command-set that matches the terminology they are familiar with. In some embodiments, the API may support formats including HTTP, JSON, or proprietary object serializations via a plug-in system, while allowing developers to use common get and post abstractions. Referring briefly to FIG. 3F, illustrated is another block diagram of an embodiment of an enterprise management system illustrating communication via the API 374. As shown, the API 374 may be used to provide an abstraction layer for one or more client-side interfaces 380, such as an ActiveX browser client, a white label interface, a SOAP client, or any other type of interface, to communicate with the system core components 370 via an application protocol layer 372. In some embodiments, other interfaces, such as a COM client, may communicate directly with the enterprise management system without using API 374. This may reduce the complexity needed in the core components 370 by allowing the core to communicate with clients via HTTP or JSON GET and POST methods or XML POST commands.

Returning to FIG. 3C, in some embodiments, content may move from input stage 302 to output stage 304 along a predetermined workflow. During execution of the work flow, each content item or asset may have an associated status. In some embodiments, a workflow stage refers to a certain condition or requirement that should be implicitly or explicitly met before the process can proceed to the next step in the workflow. For example and by way of analogy, a metaphoric process of taking a shower may be described as a workflow. The stages may comprise, for example: undressing; preparing soap; preparing toothbrush and shaving equipment; starting the shower; testing for the right temperature; stepping under the shower; performing cleaning activities; rinsing; stopping the shower; drying off; and dressing. However, not all stages are mandatory for the process to complete. For example, one might not want to wash at all but rather just want to freshen up (or warm up). The order of steps though is fixed: for example, it is not wise to step into the shower while dressed. While the process runs the subject undergoing the process moves through different statuses: undressed, dry, dirty, cold, wet, warm, soaped, clean, dry again, dressed again.

Similar stages and dependencies of statuses may be applied to content items or assets. For example, in some embodiments, in order to get content items into the EMS system the following workflow stages are implemented:

1. Authentication The sender is authenticated by EMS or EMS has to authenticate itself to the contributing party. This stage may not be mandatory in all process flows.
2. Authorization The sender is authorized by EMS or EMS has to authorize itself with the contributing party. This stage may not mandatory in all process flows.
3. Ingestion The required information is sent to EMS or retrieved by EMS.
4. Integrity checking The received information is checked for integrity. For example, metadata information may be checked for completeness and syntax, and content items may be verified for format and lack of corruption, such as by comparison to an MD5 hash.
5. Classification The metadata and content items are classified and possibly new metadata is automatically generated to better describe the received content items.
6. Translation If applicable the metadata is translated to fit the EMS internal data model.
7. Conversion If necessary the content items are converted to a predetermined format needed further EMS processing.
8. Storage Both metadata and content items are stored in the applicable storage places for later EMS processing in the Enrichment 204 and Output 206 stages.
In many embodiments, after stage 4 (Integrity checking), the content item may have status of ‘Initial’, and after stage 8 (Storage) the status may be updated to ‘New’.

Statuses that may be used, in some embodiments, include:

Initial The item is ingested into the system but is not yet prepared for further processing. This status may be automatically generated by the system.
New The item is stored in the system and ready for further processing. This status may be generally automatically generated by the system.
Pre published The item is (possibly manually) verified and proposed for publishing. In many embodiments, this status may be skipped. In some embodiments, it may be used, for example, to allow an editor in chief to inspect items proposed by editors before final publishing.
Published The item is published and is now available for all further workflow Stages and EMS processing. In many embodiments, EMS will process only published items in order to automatically create distributions. If required, in some embodiments, EMS may automatically change the status of items from ‘New’ to ‘Published’ to support fully automated ingestion and distribution.
Blocked The item is blocked. In some embodiments, this may be a temporary status that allows for update or correction.
Follow-Up The item is superseded by a newer content item. The ‘Follow-up’ status makes the content item unavailable for normal selections but allows for the support of conversation threads and content history viewing. This status may be automatically generated by the system.
Expired The item is past its expiration date and is no longer available for normal selections. This status may be generated by the system.
Deleted The item is marked as deleted. The item itself still exists in the system but could be eligible for removal.
Purged The item is physically removed from the system. Potentially its metadata can be removed as well.

Similarly, workflows during the enrichment stage 204 may be linked to statuses. In many embodiments, workflow defined for the enrichment stage 204 may depend on the business case supported. If, for instance, all processes are fully automated, workflows will be different from manual driven processes. Automatic selections of content items may be performed by inspecting and processing applicable profiles. Manual selection, in general, may involved presenting users with selection lists and processing the resulting collection of content items.

In one example embodiment of a workflow process in the enrichment stage 204, consider a ‘buy-transaction’ of content items by a consumer. In this case all workflow stages (steps) may be mandatory. The user may select a number of content items, assemble them in an order, pay for the order and receive the resulting packaged items. In one embodiment, the workflow may be viewed as follows:

1. Access control The access rights of the user are checked against its credentials and views are aligned to these rights.
2. Order composition The user selects the items of interest and assembles them in a temporary ‘basket’ or shopping cart.
3. Confirmation The user finished selecting. The system asks for final confirmation on the content of the basket or shopping cart.
4. Payment The user pays, using one of the supported payment methods, for the selected content items.
5. Order ingestion The order is ingested into the EMS system for further processing by the Output Stage.

In some embodiments, in order to allow for successful distribution of content items in the Output Stage 206, the following workflow stages may be implemented:

1. Assembly The content items necessary to complete the selection that was calculated by the Enrichment Stage are assembled and identified
2. Concatenation If so indicated, several content items are concatenated to effectively create new content items that should be distributed. This could be, for instance, merging two audio or video items to create a single multimedia item.
3. Conversion The content items are converted into the format suited for the receiver.
4. Digital Rights Management If indicated, digital rights management is applied to the content item before delivery to the distribution target.
5. Packaging If indicated, multiple content items are packaged into a distribution package.
6. Authentication EMS authenticates itself to the distribution target or vice versa if the target initiates the transfer.
7. Authorization EMS authorizes itself with the distribution target or vice versa if the target initiates the transfer.
8. Distribution The content item or package is transferred from EMS to the distribution target.

Referring briefly to FIG. 3D, illustrated is a block diagram of an exemplary embodiment of an integrated portal and marketplace system provided for a sports team. In brief overview, an integrated portal may comprise a team website or portal 322, which may provide content to fans and visitors. As discussed above, content may be ingested from the team site for further processing through workflows in the enterprise management system 320. In some embodiments, similarly, the enterprise management system may comprise or communicate with a media site 324 to gather statistical data or news content. The integrated portal may further comprise a retail portal 326 or communicate with third party retailers to provide online shopping, billing, and transaction management. Enterprise management system 320 may provide functionality for management of user data including demographic data and membership data, as discussed above, and may provide for access controls at venues, such as via ticket barcodes or RFID tags. In some embodiments, enterprise management system 320 may apply business rules to determine user behavior and predict likely purchase behavior in order to provide loyalty rewards or purchase offers.

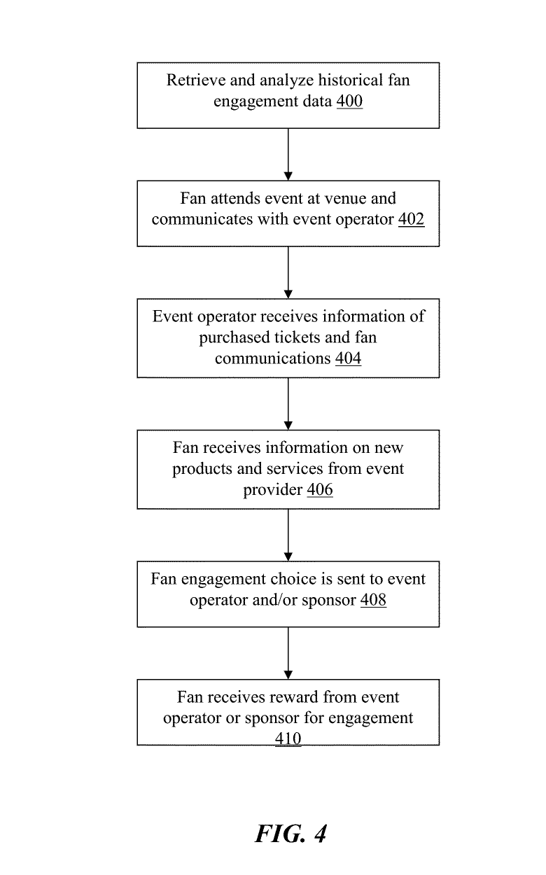

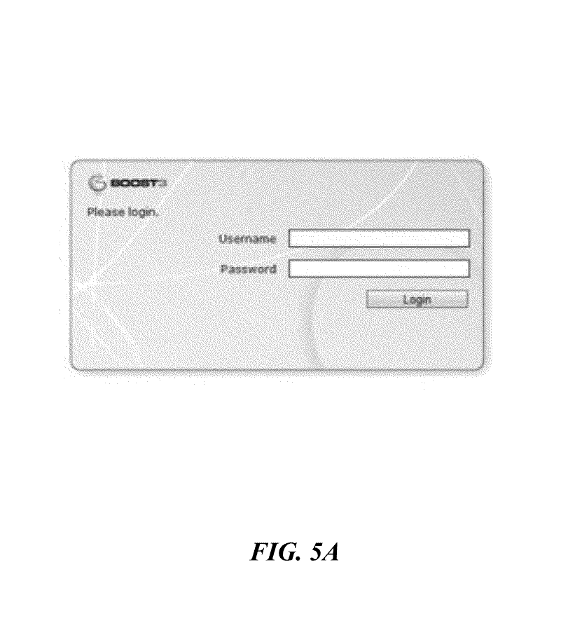

Referring now to FIG. 4, illustrated is a flow diagram of an embodiment of a method of tracking and rewarding customer behavior. At step 400, in some embodiments, the integrated portal may analyze historical fan engagement data. At step 402, a fan may attend an event at a venue, such as a game at a stadium or a concert at a theater, and may communicate with the event operator, such as the team or band. Such communication may comprise checking in via a location tracking social networking application, sending a text message or multimedia message to a team or band portal, or otherwise communicating with the portal. At step 404, the portal may receive information of purchased tickets and fan communications. In some embodiments, the portal may review cost and quality options of potential offers specific to engagement of the fan. In many embodiments, reviewing potential offers may comprise identifying the fan base and segmentation trend, identifying demographic data of the fan and one or more subgroups, identifying past behavior of the fan such as previously purchased upgrades or merchandise. At step 406, the portal may provide the fan with information on new products and services from the event operator, such as the team or band. At step 408, responsive to a selection by the fan of a purchase option or otherwise responding, such as by leaving comments on a portal message board or otherwise engaging with the portal, the fan engagement choice may be sent to the event operator and/or sponsor. In many embodiments, the portal may track fan engagement and gaps and costs in utilization of various programs and services. Fan engagement patterns and behavior may be provided to the operator and/or sponsor to better tailor future offerings. At step 410, in some embodiments, the fan may receive a loyalty reward from the event operator or sponsor for their engagement. Such rewards may comprise discounts, exclusive offers, upgrades, or other merchandise or services, as discussed above.

It may be helpful to briefly discuss several example potential user interactions with the integrated portal. The following hypothetical user experiences are provided by way of example only, and are not intended to be limiting.

In one example embodiment, through various marketing campaigns, products and services, Jeremy, an avid AIK soccer fan, visits a website for the team, www.aik.se. While browsing on the site, he sees a promotion that asks him to register for a base/free or premium fan membership package on the site. He does so utilizing his Facebook login. He then continues to connect his other accounts of Twitter, Linkedin, and YouTube. After that, he subscribes as a base member of AIK Ishockey Fan Club and receives a card which is associated with an account page where he may enter payment methods, such as a Paypal account. In some embodiments, the card may comprise a prepaid cash card which may enable him to avoid using cash at local stadium events and provides loyalty points for each card purchase. Jeremy can access his account at any moment (either by web or mobile interface) and increase his balance (prepaid) with any amount using his predefined payment method.

In a further example embodiment, Jeremy may receive email and/or SMS notifications that his favorite artist The Rolling Stones are going to perform at the local stadium. Such notifications may be responsive to an identification Jeremy provided on his online account that the Rolling Stones is one of his favorite artists, or a notification pulled from a social network service such as a Facebook page where Jeremy has indicated that he likes the band. In the notification, it may be mentioned that regular ticket sales start on July 4^{th}, but because he is a member of the AIK Ishockey Fan Club, Jeremy is allowed to buy a ticket during a currently running pre-sale.

Jeremy chooses to make an instant reservation by phone and orders two tickets. The amount may be directly withdrawn from his Paypal account, which is associated with his AIK Fan Club account, and Jeremy may receive two barcode tickets on email, MMS, or via a dedication application on his phone. In some embodiments, he may forward one ticket to his wife who will be joining him.

At home, his kids ask if they can attend the concert as well. Via his account page, Jeremy orders two extra tickets, which will be attached to his member card. Jeremy may make further purchases, including tickets for public transport or bus service to the stadium, as well as exclusive T-shirts and exclusive music tracks to be downloaded to his son's MP3 player. On the day of the event, Jeremy may receive via a Twitter Tweet or Facebook post of the latest traffic announcements and route advice.

Jeremy may travel by car to the Stadium via the advised route. In one embodiment, Jeremy may make parking reservations at a preferred parking location at the stadium via the online portal. In one embodiment, Jeremy may receive a barcode parking pass, similar to the tickets, for display on his mobile phone to an optical scanner at the parking lot of the venue, for automatic entry to the lot. In one embodiment, a personalized welcome text may be displayed mentioning the concert and Jeremy by name.

Taking an alternate travel route to the concert, Jeremy's sons arrive at the train station and take the train utilizing pre-purchased tickets tied to Jeremy's account. Arriving at the train station, a personalized welcome text may be displayed, again identifying the concert and venue. While purchasing food prior to the concert at a local fast food restaurant that is also associated with the integrated portal, Jeremy's sons may receive an SMS coupon for a free milkshake from the fast food restaurant when they make a purchase via member cards tied to Jeremy's account. Similarly, Jeremy may dine with his wife at a local Italian restaurant with a reservation made through the integrated portal, potentially earning him additional membership points or rewards. Payment may be made via his membership card or mobile phone.

Jeremy and his family may all meet at the venue entrance and enter after scanning membership cards and/or mobile phones. Concessions may also purchased via membership cards or phones, or may be pre-ordered or pre-paid while purchasing the tickets and redeemed at the concert. As a member, Jeremy may receive an exclusive notification of the set list prior to the start of the show on his phone. During the break, Jeremy orders at the self-ordering kiosk and pays as well. His sons pick up the order by number.

While traveling home with his family, Jeremy may receive via SMS the latest traffic announcements and an advised alternate route, with location tracking provided via the integrated portal and the GPS in Jeremy's phone. During the drive Jeremy may play CDs or a USB thumb drive, purchased at the concert venue with his membership card, that has been pre-filled with classic tracks from the Rolling Stones through his car stereo. Once at home, the family may decide to see the show again on a digital cable channel. Payment is also done by card, and, as with all other transactions, Jeremy receives loyalty points.

Jeremy's activity may be made available for review on a personal web page provided by the integrated portal. The web page may display activities via dashboards that Jeremy can click on and drill down for details including how many loyalty points he's obtained, what purchases he's made over a predetermined period of time, how much he's spent, what events are going on that he might be interested in (based on his personal and family interests), stats on his favorite team and players, and any other information he would like such as weather and local news. Jeremy is able to select widgets that provide the information that's important and relevant to him, creating an experience that keeps Jeremy wanting to come back for more.

Accordingly, in many embodiments, users like Jeremy may gain a membership to an integrated portal that provides purchasing and transaction handling, event notification, social networking, and additional services. In some embodiments, visitors to the portal may register for base or premium level memberships using social networking logins, such as Facebook, Twitter, LinkedIn, or Google+. During registration, the integrated portal may retrieve any profile information available from the social networking account, including wall posts, tagged photos, purchased apps, music, or videos, or other information. In some embodiments, the user may receive a welcome message via email, SMS, or social network message after registration. In many embodiments, registered users may receive periodic newsletters, team or event notifications, and/or purchase offers.

In another embodiment, visitors to an event such as a concert or sporting event may see signs around the venue advertising free WiFi access. In one such embodiment, to use the system, the visitor must register via a landing page for a free or base membership. In one embodiment, the visitor is required to supply only minimum information, such as a name and email, with the portal sending later follow-up requests for more information along with purchase offers or exclusive rewards for providing social network information. In some embodiments, the visitor may receive a membership identification code, which they may use at the venue or other venues associated with the system in the future for free WiFi access, encouraging loyalty.

In still another embodiment, visitors may connect and register with the system through a social networking site, such as Facebook. For example, the band or team may also have a social network profile, and the visitor may register through the network as a fan. In one such embodiment, upon registration, the integrated portal may retrieve social network information, including profile and wall posts as discussed above, from the user's page.

In a further embodiment of the above systems, the integrated portal may comprise functionality for encouraging member loyalty and engagement. For example, in one such embodiment, based on the user's participation on the site and on a fan page of a team, they can earn points towards becoming a top fan of the team. Interactions such as “liking” the fan page on a social networking site, referring links and stories, and mentioning the team name on wall posts multiple times may earn points. In some embodiments, registered users or members may receive communications based on their profile from the team or band. The communications may be in the form of an email, sms, or a post on Facebook or Twitter, or via any similar method. In many embodiments, the user may be able to respond directly to the communication, increasing the feeling of engagement with the team or band.

In one embodiment, users registered for a basic or free account, or users registered for free WiFi at a venue, may be provided with upgrade opportunities and incentives. For example, as discussed above, in some embodiments, users may provide only an email address and name to receive WiFi. On later providing additional information to the integrated portal, the user may become a member and receive an RFID sticker or membership card comprising a barcode or other identifier via mail. RFID stickers may be applied to a mobile phone, in some embodiments, to enable electronic wallet and near-field purchase functionality. In other embodiments, smart phone applications may provide visual codes or identifiers which may be similarly used.

In some embodiments, event partner web pages, such as venue related web sites, third-party retailers, or media organizations, may include embedded widgets or scripts that allow interaction with the integrated portal. Such widgets may monitor user interactions with the site, such as purchasing tickets or viewing band information, and may provide the user with the opportunity to purchase parking or event tickets, directions and traffic information, public transportation information, promotion deals or special services, or other merchandise or services, as discussed above.

The portal may further be used to provide SMS reminders or notifications (e.g. injury reports, starting line-ups, set lists, etc.) to members or registered users, in some embodiments for a small fee. Membership privileges may include discounts at venue or team or band related online shops, priority ordering of tickets or merchandise, or other rewards.

In some embodiments, as discussed above, users may purchase parking tickets through an online shop, with access to the parking lot at the venue made via the membership card or sticker. Similarly, members may purchase concessions at a venue using their membership card for ordering and payment, may participate in on-site, event related games or online experiences such as scavenger hunts, may order concessions from their seat via smart phone and venue WiFi, and may purchase and download add-ons, including music and videos. In a further embodiment to draw new users, unregistered visitors may visit an on-site kiosk to purchase a pre-paid service card, which may be used like a membership card, with associated benefits, discounts and rewards, although without potentially earning points or receiving customized offers. This may encourage new users to try the system and later register.

In some embodiments, users or members may be able to upgrade their membership to an exclusive or VIP membership, allowing additional privileges. For example, in one embodiment, exclusive members may be allowed into a pre-reserved parking area, a lounge at the venue, backstage, or be allowed other special privileges, such as ordering delivery of concessions to a seat, special reports, set lineups, backstage videos, after-party access, or other features.

### C. Exemplary Embodiments of an Integrated Online Portal

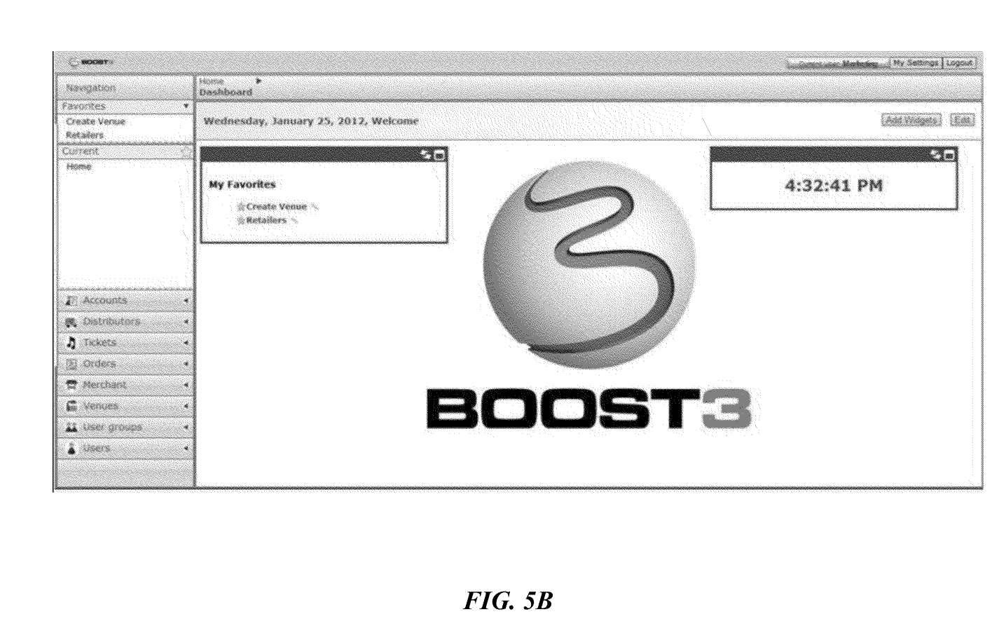

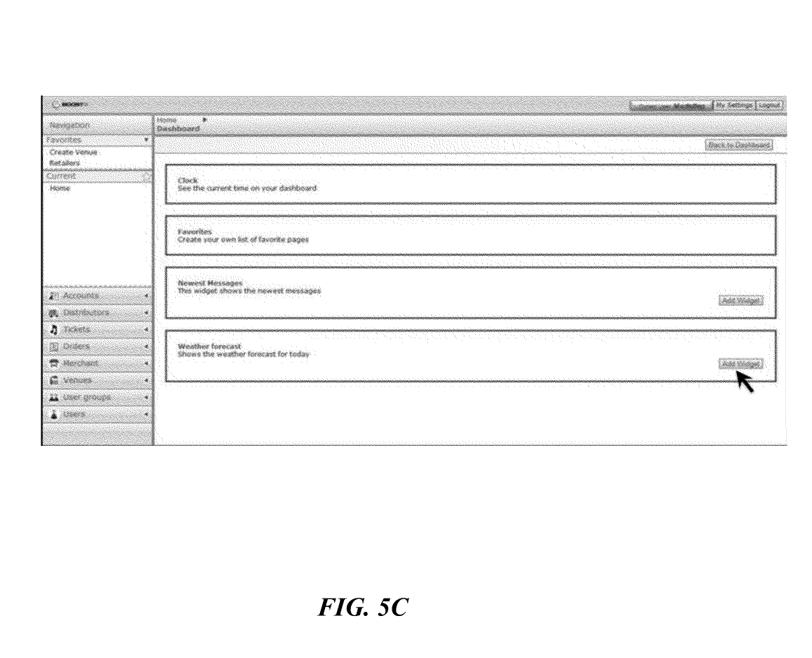

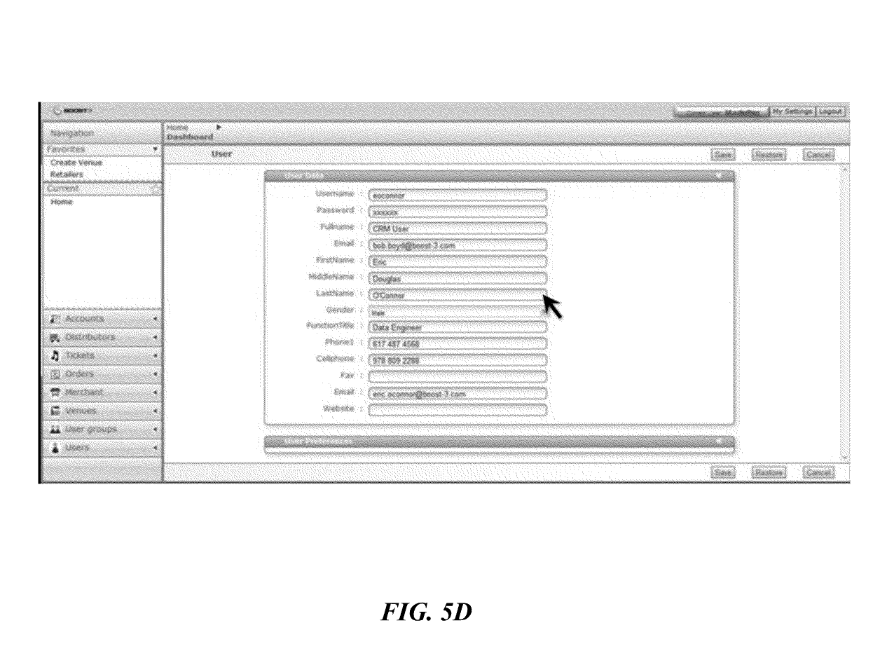

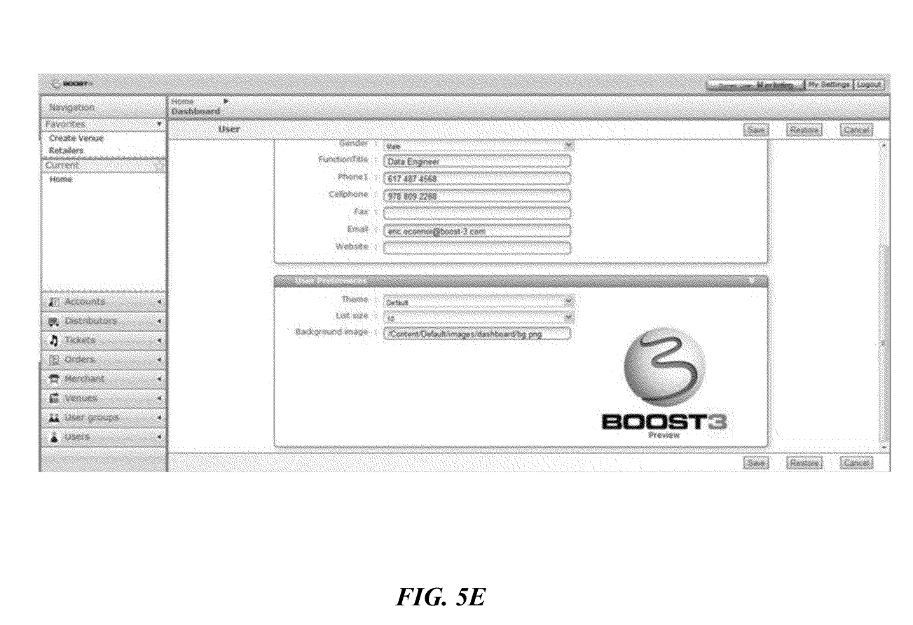

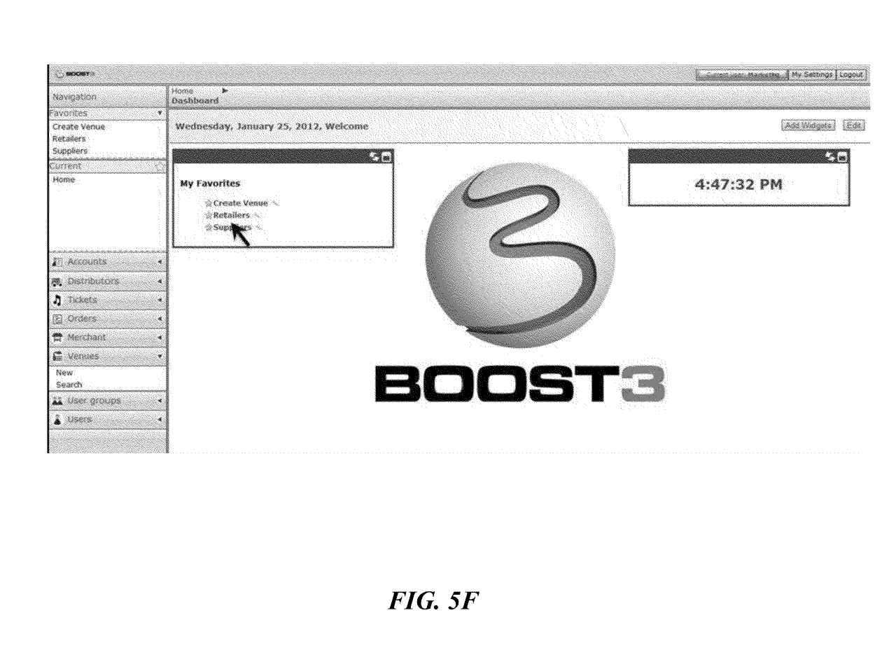

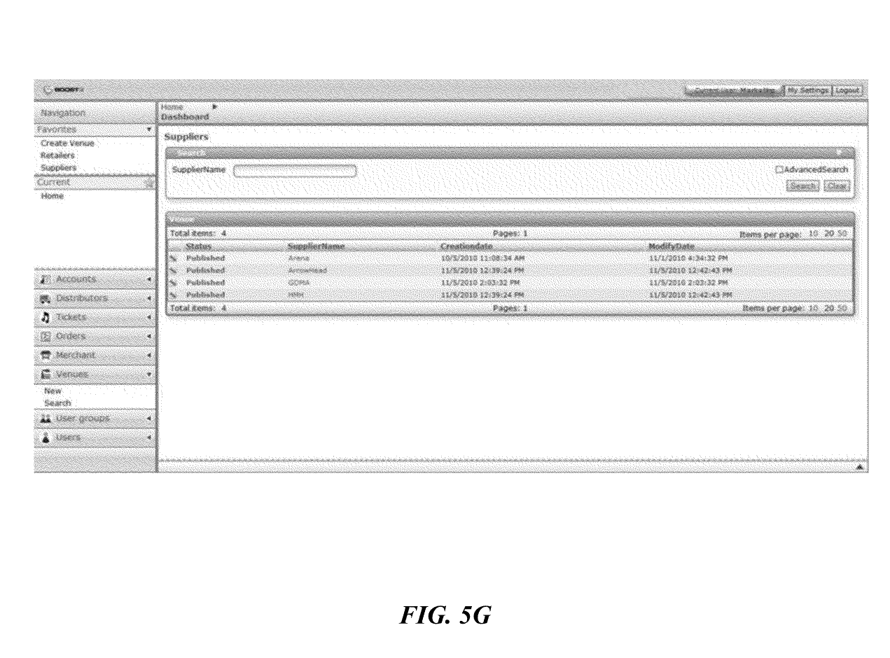

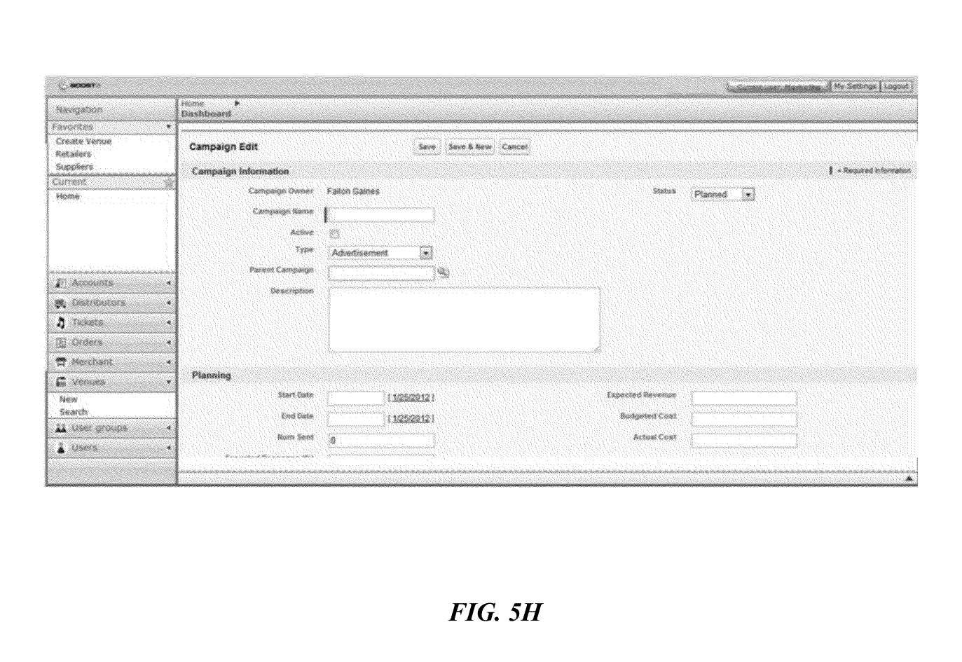

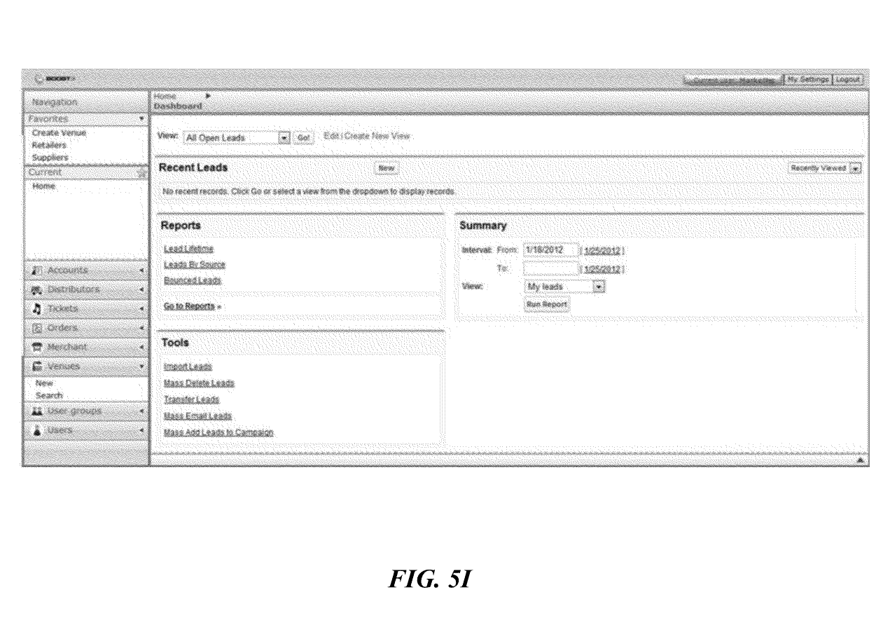

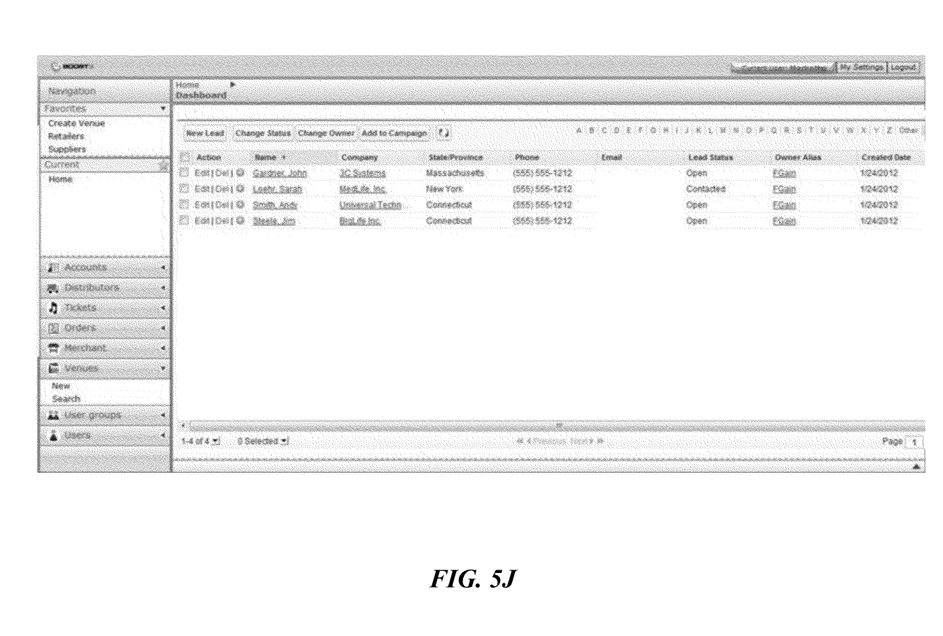

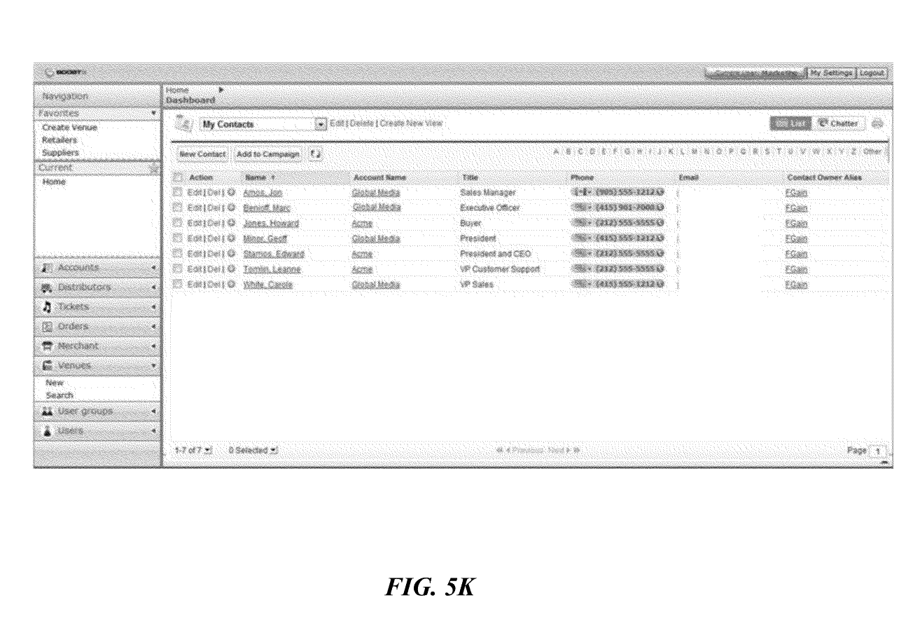

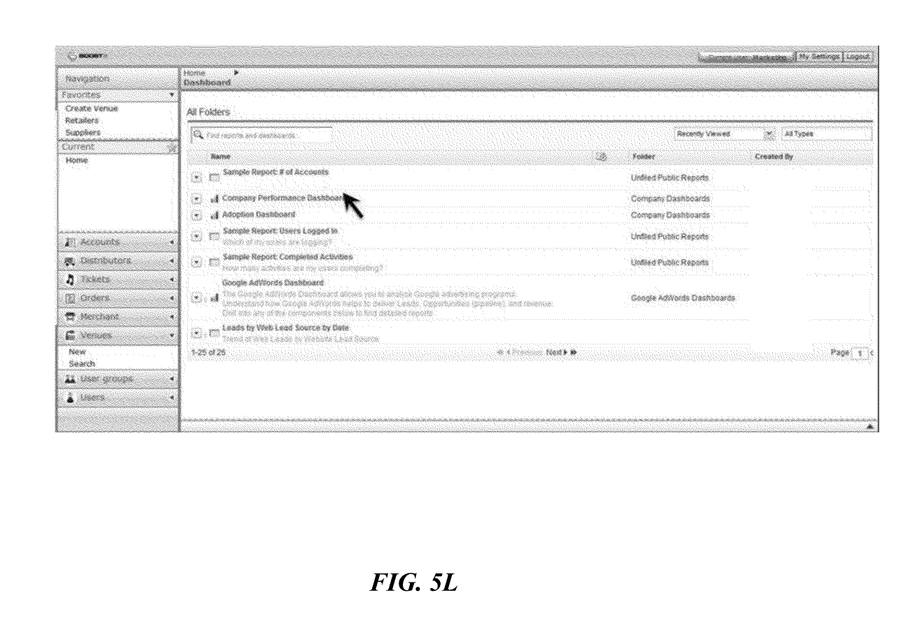

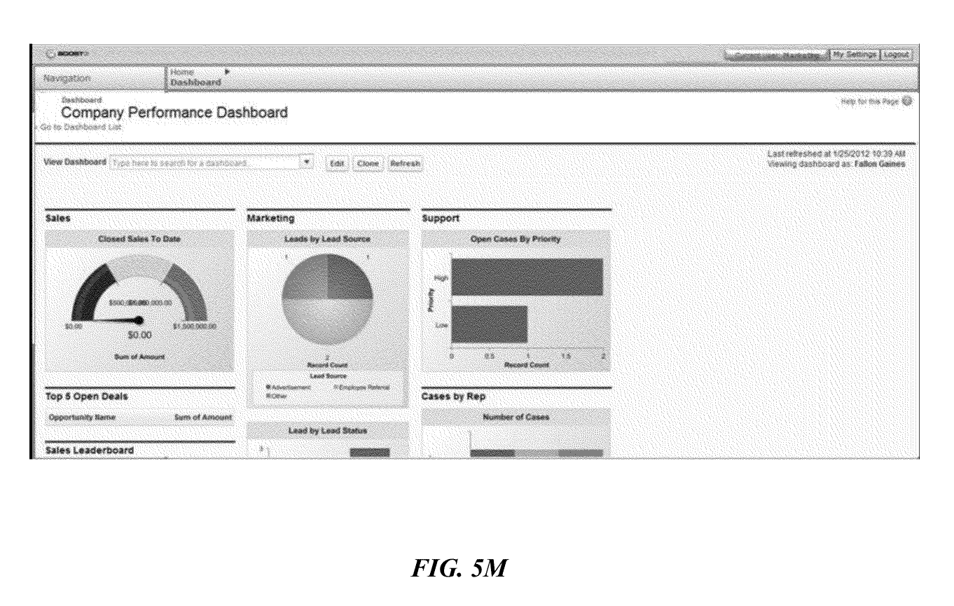

Illustrated in FIGS. 5A-5M are screenshots of exemplary embodiments of an integrated online portal incorporating the systems and methods described above, including management and configuration features of the enterprise management system desktop application. The following examples are intended to be non-limiting, but may be useful for explanatory purposes. Nonetheless, one skilled in the art may readily envision other embodiments that do not depart from the scope of the systems and methods described herein. Furthermore, although many of the examples shown are directed to embodiments in which the inventory items are tickets to shows or sporting events, as discussed above, the systems and method discussed herein may be applied to other items, services, or attractions including travel tickets, hotel reservations, restaurant reservations, books, clothing, music, movies, time coupons for a service such as a multiplayer game, cloud computing application, or VoIP service, or any other purchasable item or service.

In brief overview, an administrator may log in via a login screen as shown in FIG. 5A, providing a username and, in some embodiments, a password. Upon login, the administrator may be provided with a portal or landing page, as shown in FIG. 5B, giving access to other features of the portal such as viewing accounts, distributors, tickets, order, merchants, venues, users, or user groups.

As shown in FIG. 5C, administrators and/or users may be able to add widgets to their home page or landing page, adding additional functionality such as news reports, weather or traffic reports, or other features. Similarly, as shown in FIG. 5D, users may provide various items of user data to build a user profile. As discussed above, in some embodiments, user profile data may be obtained from third-party social networking sites via user login. Additionally, as shown in FIG. 5E, a user or administrator may be able to customize various aspects of the portal including theme and font size.

In one embodiment, an administrator may select to view suppliers, as shown in FIG. 5F, from a link on the home page. As shown in FIG. 5G, suppliers may comprise various inventory providers, including a venue providing tickets, or a concession or merchandise provider.

In some embodiments, an administrator may generate a campaign, which may comprise business rules for providing advertisements or other promotions, as shown in FIG. 5H. Once created, in some embodiments, campaigns may be automatically executed to provide new offers to members or visitors, or perform other functions.

In some embodiments, in addition to tracking suppliers and users, the portal may allow administrators to track leads or reports of potential new suppliers or vendors, advertisers, sponsors, users, or other features, as shown in FIG. 5I for entering a new lead, and 5J, showing a table of existing leads and statuses. Similarly, as shown in FIG. 5K, the portal may allow an administrator to view and manage a list of contacts.

In addition to database management functions, in many embodiments, the integrated portal may be used to generate reports, as shown in FIG. 5L. Reports may be generated according to predetermined templates, or may be generated according to customized parameters. In one embodiment, as shown in FIG. 5M, a report may comprise a graphical report or dashboard showing dynamic indicators of usage, revenue, or other features.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

Having described certain embodiments, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed:

1. A system for providing an integrated marketplace system, the system comprising:
an integrated marketplace system configured to execute on one or more processors and to receive data identifying fan behavior from one or more social networks via one or more network interfaces;
wherein the integrated marketplace system is configured to determine product or service recommendations for a specific fan based on the data; and
wherein the integrated marketplace system is configured to provide an electronic interface for the fan to purchase one or more recommended products or services with a purchase of a ticket to an event.
